(19) United States
(12) Patent Application Publication
(10) Pub. No.: US 2003/0028890 A1
(43) Pub. Date: Feb. 6, 2003

(54) Video and digital multimedia acquisition and delivery system and method

(76) Inventors: William D. Swart, Fairfax, VA (US); John S. McCoskey, Castle Rock, CO (US); Michael L. Asmussen, Oak Hill, VA (US)

Correspondence Address: Dorsey & Whitney LLP, Suite 300 South, 1001 Pennsylvania Avenue, N.W., Washington, DC, 20004, US

(21) Appl. No.: 09/973,081

(22) Filed: Oct. 10, 2001

Related U.S. Application Data
(63) Continuation-in-part of application No. 09/920,723, filed on Aug. 3, 2001.

(51) Int. Cl. H04N 7/173

(52) U.S. Cl. 725/91; 725/98; 725/118; 725/114

(57) ABSTRACT

An aggregator, operating in a digital communications network, includes a request and results processing server, a search engine server coupled to the request and results processing server and a content acquisition server coupled to the request and results processing server. A request and results processing server receives a request for content, the search engine server searches for the content and the content acquisition program acquires content for delivery to the user. The request and results processing server includes a search request processor that receives information related to a user's search request and provides the information to a search results form builder that creates an electronic search request. The search request may be augmented by using a content suggestion engine to add additional search terms and descriptions to the search request. The aggregator may also include a decoder that decodes program content and program metadata from remote sources for storage at the aggregator, and an encoder that encodes content metadata and programs for delivery to the user. The aggregator may also comprise one or more crawlers, such as a content crawler, to look for program content in one or more digital communications networks.

### RELATED APPLICATIONS

This application is a continuation-in-part of co-pending U.S. patent application Ser. No. 09/920,723, entitled “Video and Digital Multimedia Aggregator,” filed on Aug. 3, 2001, which is hereby incorporated by reference.

The following U.S. patents also are incorporated by reference:

U.S. Pat. No. 5,798,785, entitled “Terminal for Suggesting Programs Offered on a Television Program Delivery System;”

U.S. Pat. No. 5,986,690, entitled “Electronic Book Selection and Delivery System;”

The following co-pending U.S. patent applications also are incorporated by reference:

patent application Ser. No. 07/991,074, filed Dec. 9, 1992, entitled “Remote Control for Menu Driven Subscriber Access to Television Programming;”

patent application Ser. No. 08/906,469, filed Aug. 5, 1997, entitled “Reprogrammable Terminal for Suggesting Programs Offered on a Television Program Delivery System;”

patent application Ser. No. 09/191,520, filed Nov. 13, 1998, entitled “Digital Broadcast Program Ordering;”

patent application Ser. No. 09/289,957, filed Apr. 13, 1999, entitled “Electronic Book Alternative Delivery Systems;”

patent application Ser. No. 09/289,956, filed Apr. 13, 1999, entitled “Electronic Book Alternative Delivery Methods;” and

patent application entitled “Video and Digital Multimedia Aggregator Remote Content Crawler,” and patent application entitled “Video and Digital Multimedia Aggregator Content Suggestion Engine,” filed on Aug. 3, 2001.

### TECHNICAL FIELD

The technical field is television program and digital multimedia delivery systems that incorporate intelligent and flexible program search and delivery mechanisms.

### BACKGROUND

Cable television delivery systems greatly expanded the array of programs available to television viewers over that provided by over-the-air broadcast systems. Subsequently, satellite television delivery systems, and in particular, digital satellite broadcast systems further expanded the viewing choices for consumers. In the near future, digital broadcast television systems will provide many more programming choices for consumers.

In addition to television programming delivered through television program delivery systems, other programs and events may be sent to consumers. These other programs and events include streaming video sent over wired and unwired, narrowband to broadband services, digital audio programs, and other multimedia data.

Unfortunately, customers are still limited in their television viewing choices by the local and regional nature of television delivery systems. For example, a broadcaster in Boston may provide programming of local interests to people in Massachusetts while a broadcaster in Seattle may provide different programming to people in the Seattle area. A person in Boston generally cannot access Seattle programming, other than programming that is provided at a national level.

In addition to this local/regional market segregation, many other sources of programming and events may not be available in a specific viewing area. These other sources may include audio programming, streaming video, local or closed circuit television programming (e.g., education television programming provided by a state education department) and other programming.

Even if certain programming is available in a local viewing area, a viewer may not be aware of its existence. This situation may be the result of a large array of available programming coupled with a limited program menu or guide. The program guide may be limited in that not all available programming can be listed, some programming changes occur that are not reflected in the program guide, and errors may exist in the program guide. In addition, the more comprehensive the program guide, the harder it is for the viewer to search and navigate the program guide to find a desired program.

### SUMMARY

The problems noted above are solved by the video and digital multimedia aggregator system and method described herein. Program content can be packaged and delivered by the system, including video, television, radio, audio, multimedia, computer software, and electronic books, or any content that can be delivered in digital format.

The aggregator comprises a request and results processing server, a search engine server coupled to the request and results processing server and a content acquisition server coupled to the request and results processing server. The request and results processing server receives a request for a program, the search engine server searches for the program and the content acquisition server acquires a program for delivery to the user. The request and results processing server includes a search request processor that receives information related to the user's search request and provides the information to a search results form builder that creates an electronic search request. The search request may be augmented by using a content search suggestion engine to add additional search terms and descriptions to the search request. The aggregator may also include a decoder that decodes program content and program metadata from remote sources for storage at the aggregator, and an encoder that encodes content metadata and programs for delivery to the user. The aggregator may also comprise one or more crawlers, such as a content crawler, to look for program content in the digital communications network.

The search engine server searches at least a local content database. The local database comprises at least two file types. A content file includes a complete program content file. For example, the 1997 movie Titanic may exist in the local content database as a complete program content file. The complete program content file may also include a reference content or metadata that contains additional information related to the content. Such additional information in the reference content may include: a program description, including program rating, program description, video clips, program length, format (e.g., 4×3 television or 16×9 movies), and other information; billing information and digital rights management information; viewing statistics, including number of times viewed, dates/times viewed, identity of users viewing the program; advertisement information to allow ads to be inserted during viewing of the program; and other information.

The additional information in the reference file may be provided in whole or in part to the system users. For example, the aggregator may provide a program description and accompanying video clips to selected systems users. The reference file may also be used by the aggregator for system administration purposes. For example, billing and digital rights management information may be used to collect appropriate fees from system users and to provide such collected fees to the entities owning rights in the content.

A remote content crawler continually crawls the digital communication network looking for content to provide to the aggregator. The content provided to the aggregator may be stored in a form of an entire content file. For example, the content may include an entire movie, television program or electronic book. Alternatively, the content provided to the aggregator may be a reference to a content file that is stored at, or that will be available at one of the remote locations. For example, the content may be a reference to a future, scheduled live sports event that will be made available to system users. The sports event may be provided for a one-time fee, as part of a sports package, for which a fee is collected, or as a free event. In the examples discussed above, the content may be stored at the aggregator, and may subsequently be provided to system users. For the example of the live sports event, the aggregator may store the live sports event and may then provide the sports event as a replay, in addition to facilitating live viewing of the sports event.

### DESCRIPTION OF THE DRAWINGS

The detailed description will refer to the following drawings in which like numerals refer to like elements, and in which:

FIG. 1 is a block diagram of primary components of a content search, packaging, and delivery system;

FIG. 2 is a block diagram of the components of the content search, packaging, and delivery system configured to deliver content to a set top terminal;

FIG. 3 is a block diagram of the components of the content search, packaging, and delivery system configured to deliver content to a personal computer terminal;

FIG. 4 is a schematic of the components of the content search, packaging, and delivery system showing subsystems of an aggregator, a user terminal, and a remote content server;

FIG. 5 is a schematic of subsystems of a request and results processing server and components with which the processing server interacts as part of the content search, packaging, and delivery system;

FIG. 6 is a schematic of subsystems of a content acquisition server and components with which the content acquisition server interacts as part of a content search, packaging, and delivery system;

FIG. 7 is a schematic of subsystems of a content delivery server and components with which the content delivery server interacts as part of the content search, packaging, and delivery system;

FIG. 8 is a schematic of subsystems of a database administrator as part of the content search, packaging, and delivery system;

FIGS. 9A-9C show a flowchart describing programming content delivery from the aggregator or a remote content server to the user terminal;

FIG. 10 is a schematic of the components of the content search, packaging, and delivery system showing subsystems of an alternate embodiment of an aggregator, a user terminal, and remote content sources;

FIG. 11 is a schematic of subsystems of a content acquisition system and components with which the content acquisition system interacts as part of a content search, packaging, and delivery system;

FIG. 12 is a schematic of subsystems of a remote content consolidation system and the content acquisition system with which the remote consolidation system interacts as part of a content search, packaging, and delivery system;

FIG. 13 is a schematic of subsystems of a content delivery system and components with which the content delivery system interacts as part of a content search, packaging, and delivery system;

FIG. 14 is a schematic of local content sources that provide content to the content delivery system as part of the content search, packaging, and delivery system;

FIG. 15 is a schematic of subsystems of a communications system and components with which the communications system interacts as part of a content search, packaging, and delivery system;

FIG. 16 is a schematic of subsystems of a content transmission system which is part of a communications system and subsystems of a wide area distribution system which is part of a content search, packaging, and delivery system.

FIG. 17 is a block diagram of operational modules of a content acquisition method that may reside in the content acquisition system of FIG. 11;

FIG. 18 is a block diagram of operational modules of a content delivery method that may reside in the content delivery system of FIG. 13; and

FIG. 19 is a block diagram of operational modules of a communications method that may reside in the communications system of FIG. 15.

### DETAILED DESCRIPTION

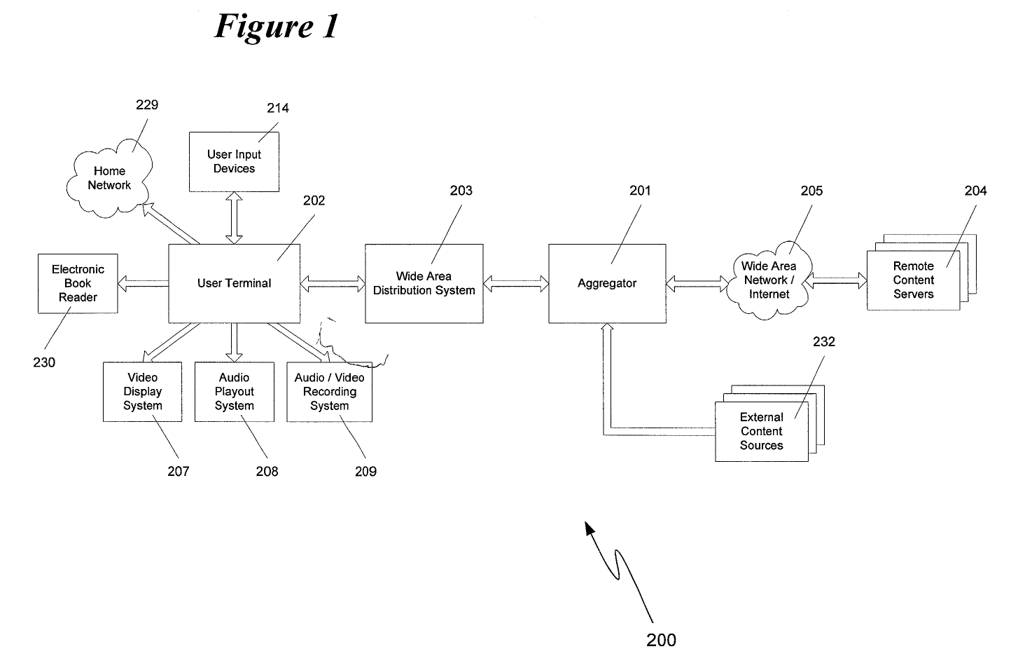

FIG. 1 is a block diagram of a content search, packaging, and delivery system 200. The content to be packaged and delivered by the system 200 includes video, television, radio, audio, multimedia, computer software and electronic books. Components of the system 200 include an aggregator 201 and a user terminal 202, which are connected using a wide area distribution system 203. Other components are remote content servers 204 that exchange data with the aggregator 201 using a wide area network/Internet 205 connection and external content sources 232 that provide other content data to the aggregator 201. The user terminal 202 may incorporate a video display system 207, an audio playout system 208, an audio/video recording system 209, user input devices 214, an electronic book reader 230, and a connection to a home network 229 to interact with other devices in the user's home environment. Alternatively, one or more or all of the video display system 207, the audio playout system 208, the audio/video recording system 209, and the electronic book reader 230 may be separate components that are coupled to the user terminal 202.

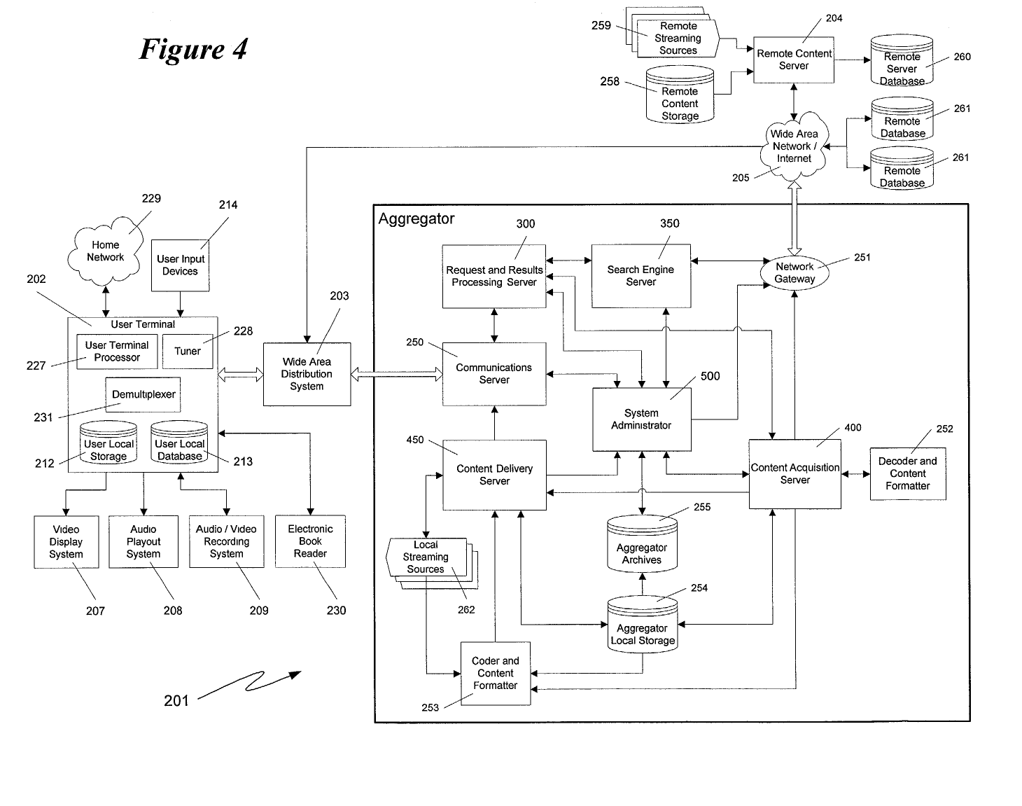

The system 200 allows a user to enter search parameters, such as keywords and category headings, and have the aggregator 201 use these parameters to locate, package, and deliver content to the user terminal 202 from numerous sources. The requests and content deliveries can be sent over communications links including, but not limited to, telephone lines, coaxial cable, fiber-optic cable, wireless connections, satellite networks, terrestrial broadcast systems, wide area networks, the Internet, physical media distribution, and other communication media collectively represented by the wide area distribution system 203. The numerous sources of content are shown in FIG. 4 and include, but are not limited to, an aggregator local storage 254, local streaming sources 262, remote content storage 258, and remote streaming sources 259. In an embodiment, the local streaming sources 262 are comprised of the audio and video channels being delivered using a cable headend system that may house the aggregator 201.

The system 200 will take a user's search request and may perform a search of virtually every active and scheduled radio and television channel in the world, as well as archived sources of video and audio programming such as movies and recorded audio sources, and sources of other multimedia, software, and electronic book content. In an embodiment, the system 200 will also search Internet Web sites and other online databases. The user will then be able to select programming or other content for download based on the search results. In an embodiment, the download, or delivery, process can be fulfilled by making the content available on a specific channel of a cable television or other broadcast system, or by transmitting the content using a digital communications protocol, such as the Internet standard TCP/IP, for example. In addition, the content search, packaging, and delivery system 200 is capable of formulating and presenting a list of suggested content based on an analysis of the user's current search parameters, stored information about previous searches and previously selected content downloads and other user-specific or related information. The system 200 is also capable of notifying a user prior to the start time of selected programming and availability of other content using such notification as an electronic mail message and/or an on-screen message indicating that the scheduled program will be broadcast at a specified time. The system 200 may support one or more digital rights management (DRM) systems to track the copyrights and usage rights associated with downloaded content and bill the user's account as appropriate and provide any license and usage fees to the content provider. The system 200 may implement a users' privacy protection scheme allowing users to control what information is gathered, limit what is done with that information, and review and delete information in the user's profile if desired.

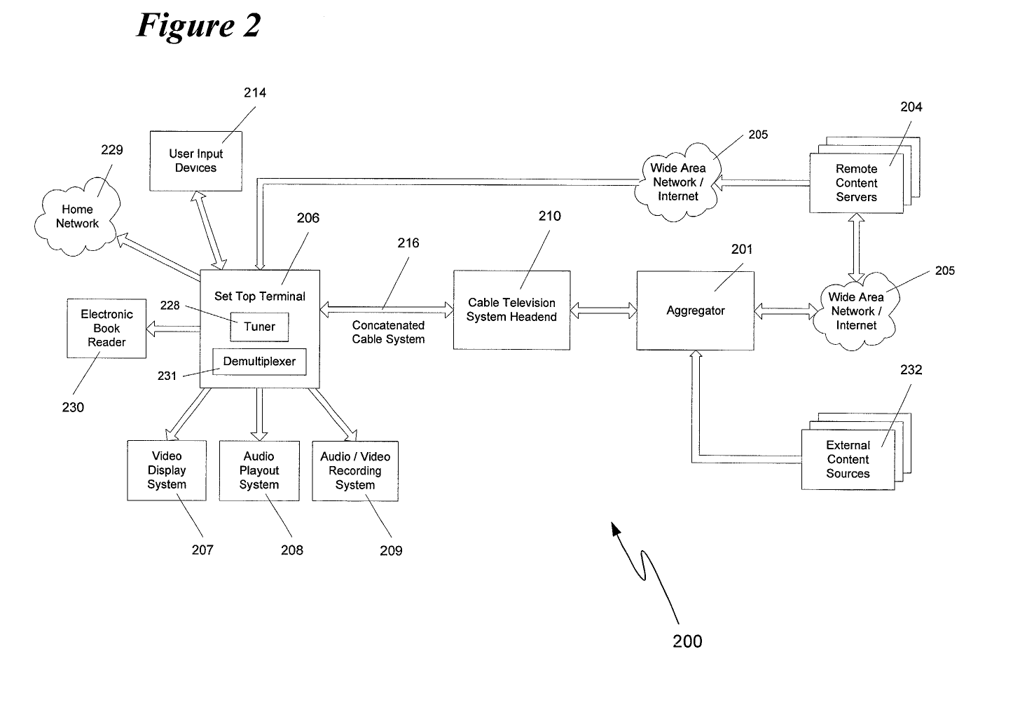

An overview of an embodiment of the system 200 is shown in FIG. 2 where the user terminal 202 is a set top terminal 206 that communicates with the aggregator 201 through a cable television system headend 210, thereby making use of the cable television system headend 210 high bandwidth concatenated cable system 216. Further, the set top terminal 206 system may include a tuner 228, a demultiplexer 231, a video display system 207, an audio playout system 208, an audio/video recording system 209, user input devices 214, an electronic book reader 230, and a connection to the user's home network 229. These components may be used to tune, select, view, listen to, and store audio and video programming and other content delivered by the search, packaging, and delivery system 200. FIG. 2 also shows a communications path from one or more remote content servers 204 through the wide area network/Internet 205 directly to the set top terminal 206, which bypasses the aggregator 201 and cable television system headend 210. This path may be used in the case where the requested content is available in the required format from the remote content server 204 and is authorized for direct delivery to the user. In an alternative embodiment, the aggregator 201 is collocated with the cable television system headend 210 that is acting as the wide area distribution system 203 as is the case when a cable television system is also serving as the user's Internet service provider.

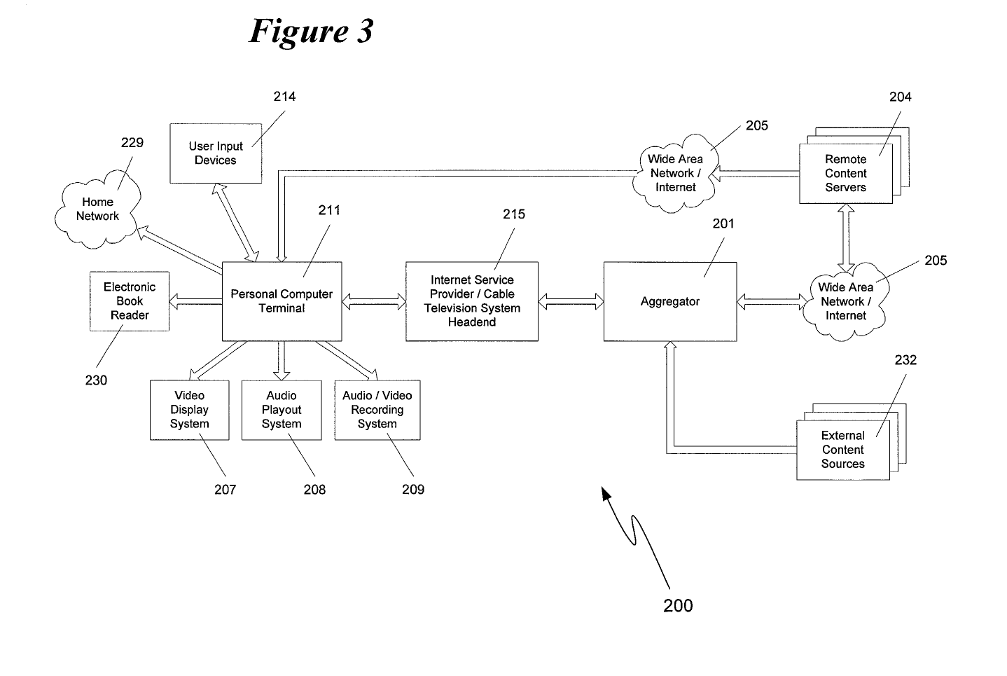

An overview of another embodiment of the system 200 is shown in FIG. 3, where the user terminal 202 is a personal computer terminal 211 that communicates with the aggregator 201 through an Internet service provider/cable television system headend 215. In this case, the content may be delivered by a cable headend that is operating as an Internet service provider (ISP). The personal computer terminal 211 also may include a video display system 207, an audio playout system 208, an audio/video recording system 209, user input devices 214, an electronic book reader 230, and a connection to the home network 229. A communications path also exists from one or more remote content servers 204 through the wide area network/Internet 205 directly to the personal computer terminal 211, which bypasses the aggregator 201 and the Internet service provider/cable television system headend 215 in the case where requested content is in the required format and is authorized for direct delivery to the user.

The user can receive video and audio programs (i.e., the content) in a number of different ways. First, the tuner 228 in the user terminal 202, shown in FIG. 2, can simply tune to the desired program, or the demultiplexer 231 can select a program from a digital multiplex, thereby displaying the program at the appropriate time. However, the desired program may not be broadcast by the user's cable television system headend 210, or the user would like to watch a program supplied by the local headend, but not subscribed to by the user, e.g., a boxing match broadcast by a premium channel that the user does not ordinarily receive. In these examples, the program can be delivered to the user by the aggregator 201 using the telephone lines, fiber-optic transmission lines, or other communication media, or using the cable television system headend 210. In an embodiment, the aggregator 201 can supply the desired program to the user by pulling programs from program delivery systems in the United States and abroad and delivering the program to system users. Therefore, a user can have access to programs outside the user's immediate viewing area.

FIG. 4 shows an embodiment of the system 200 and system components in more detail. At a user's location, the user terminal 202 includes a tuner 228, a demultiplexer 231, a user terminal processor 227, user local storage 212 and user local database 213. Coupled to the user terminal 202 may be user input devices 214, a video display system 207, an audio playout system 208, an audio/video recording system 209, an electronic book reader 230, and a connection to the home network 229.

The user terminal 202 is coupled through the wide area distribution system 203 to the aggregator 201 and further through the wide area network/Internet 205 to remote program sources. The remote program sources include remote streaming sources 259 and remote central storage 258. The remote program sources also include remote databases 261 and, through the remote content server 204, a remote server database 260.

The aggregator 201 may include a communications server 250 that communicates with the user terminal 202 through the wide area distribution system 203. The communications server 250 receives inputs from a request and results processing server 300, a content delivery server 450 and a system administrator 500. The content delivery server 450 receives inputs from a coder and content formatter 253 and a content acquisition server 400. The content delivery server 450 also accesses an aggregator local storage 254 and local streaming sources 262. Finally, the content delivery server 450 provides an output to the system administrator 500.

The coder and content formatter 253 receives inputs from the content acquisition server 400, the aggregator local storage 254 and local streaming sources 262. The system administrator 500 receives inputs from the content and delivery server 450, and communicates with the content acquisition server 400, the request and results processing server 300, a search engine server 350 and aggregator archives 255. A decoder and content formatter 252 is coupled to the content acquisition server 400. Finally, a network gateway 251 couples components of the aggregator 201 with the remote content server 204 through the wide area network/Internet 205.

Content received at the aggregator 201 may be input to the formatter 253. The formatter 253 reformats all input content into a format that is readily received by one or more user terminals 202 operably connected to the delivery system 200. In addition, the formatter 253 can store full or partial copies of content in compressed form in the aggregator local storage 254. Furthermore, the aggregator 201 can provide real-time delivery of certain content, such as a boxing match. In an embodiment, if a large number of users want a particular live program, then the cable television system headend 210 can broadcast the program on a particular channel available to all the requestors instead of broadcasting the program to each individual user over the wide area distribution system 203. See U.S. patent application Ser. No. 09/191,520, entitled Digital Broadcast Program Ordering, hereby incorporated by reference, for additional details of broadcast program delivery.

The aggregator 201 can also implement a screening process for limiting the number of programs captured to those programs with a viewing audience above a predetermined threshold. In effect, the aggregator 201 contains a filter that will pass only programs meeting the predetermined selection criteria. The filter may include programming that screens the content to reject specific items, such as adult content, for example.

The system administrator 500 records what fees should be paid and to whom. For example, the aggregator 201 will determine to whom any copyright or other fees should be paid when a program is broadcast.

The user terminal 202 may be a television, a set top terminal 206, a personal computer terminal 211 (see FIG. 3), or any device capable of receiving digital or analog data, or some combination thereof. The user terminal 202 may be equipped with user input devices 214 that communicate search criteria to the system 200 as well as navigate through the user terminal menu system and control the user terminal's other various functions. The user local storage 212 is used to store and archive content onto one or more removable and/or non-removable storage devices or media for later access. Removable storage media may include, but is not limited to, magnetic tape, magnetic disks, optical disks and modules, and electronic memory cartridges. The user local database 213 is the repository of all relevant information about a user's profile and account. The user profile and account information includes, but is not limited to, user name, password, personal information that the user has authorized for storage, billing information, other users allowed access to the account, past search criteria, past content download information, and library information about stored content. As a consumer protection, the user terminal 202 may enable the account user to view the information stored in the user local database 213 and modify certain data fields and select which data fields may be reported to a main system database within the aggregator 201. Certain fields including, but not limited to, account numbers and billing information may not be allowed this level of user access.

The user terminal processor 227 may include a central processing unit and all associated hardware, software, and firmware modules to perform all operations within the user terminal 202. These operations include, but are not limited to, managing communications with the aggregator 201 and other networked devices, processing search and download requests, displaying search and download results, managing and controlling communications with the user local storage 212 and the user local database 213, responding to user interaction with presentation of graphical user interface (GUI) menus, playing out selected programming content using various audio and video output devices, implementing the user's part of the digital rights management schema, and administering the user's account and billing. The tuner 228 and the demultiplexer 231 are used to select an audio/video channel for playout from the channels available on one or more cable television system 216 and/or other delivery systems such as a satellite system and/or off-air broadcast receiver. The term “off-air” is used to indicate that the broadcast signal can be received over the public airwaves with the use of an appropriate antenna.

In an embodiment, the user terminal 202 may incorporate selected features of the aggregator 201. For example, the user terminal 202 may include a small metadata crawler, an aggregator, and program content and program metadata storage.

The user terminal 202 communicates with the aggregator 201 using the wide area distribution system 203. Within the aggregator 201, the communications server 250 acts as the interface point to the wide area distribution system 203 for the purpose of managing primary communications to system users. The communications server 250 routes incoming user requests and associated user information to the request and results processing server 300, routes search results and content downloads through the wide area distribution system 203 to end users, and routes billing information to the end users from a customer billing server within the system administrator 500. The request and results processing server 300 performs the basic processing and routing related to user search requests, content download requests, administrative information requests, search results, related content suggestions, and programming notification.

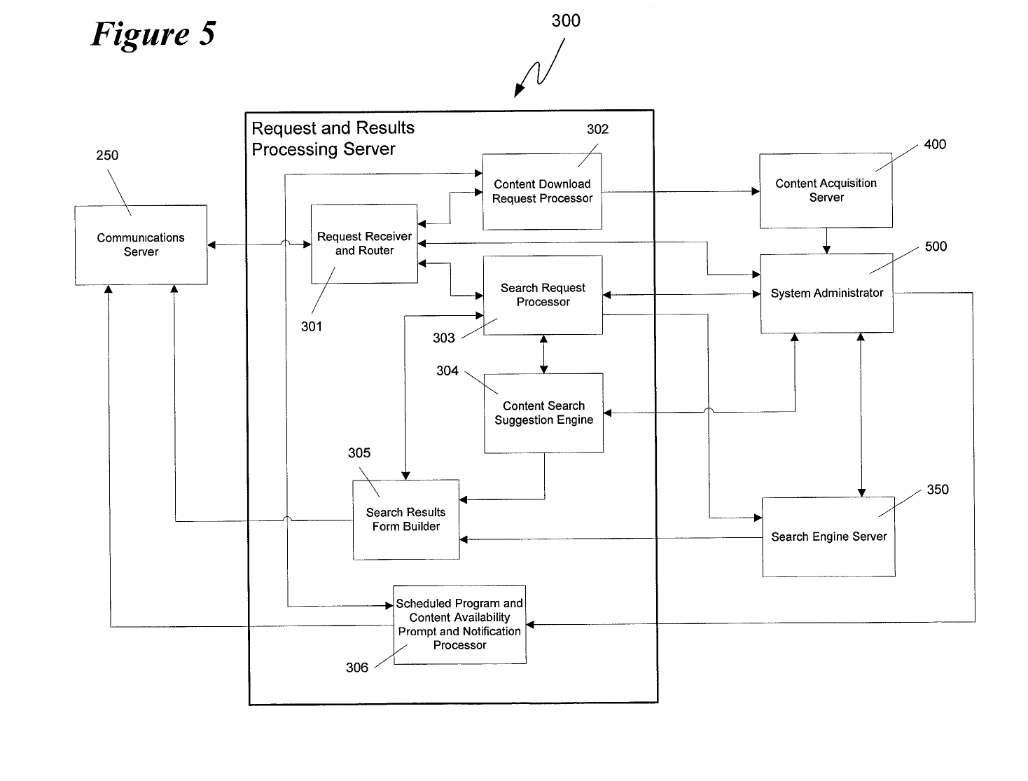

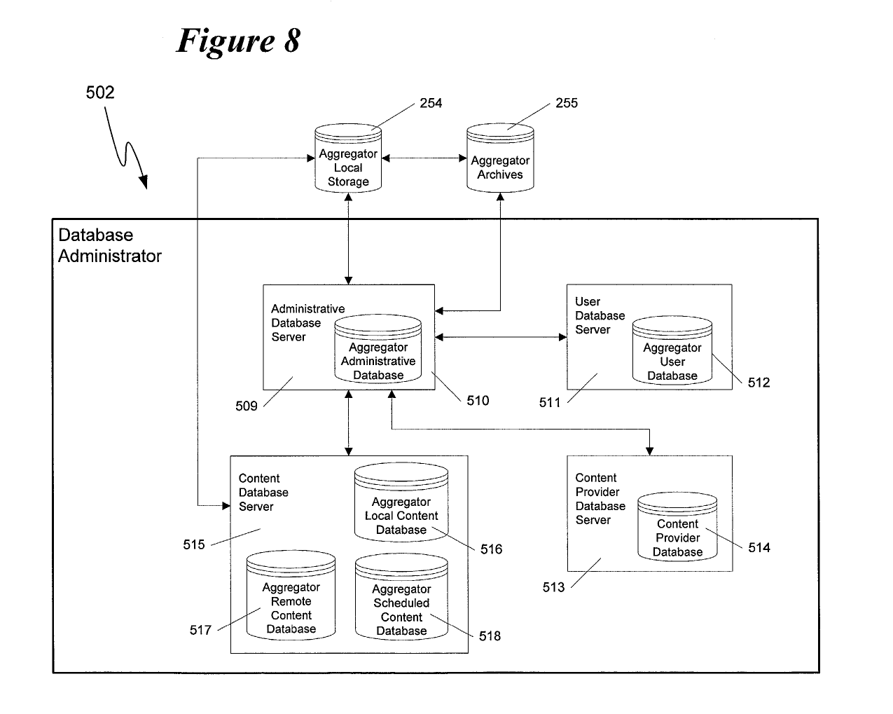

FIG. 5 shows individual subsystems of the request and results processing server 300. The types of requests from a system user include, but are not limited to, programming and other content search requests, content download requests based on results of an earlier search, and administrative information requests. Requests for administrative information may be automatically generated by the user terminal 202 or may be manually initiated by the system user. When an administrative request is received, a request receiver and router 301 opens a dialog with a database administrator 502 (see FIG. 8) within the system administrator 500, retrieves the requested system user's administrative data, and routes the data through the communications server 250 to the user terminal 202. Search requests and content download requests are routed to a search request processor 303 and a content download request processor 302, respectively. The processors 302 and 303 open a dialog with the database administrator 502 and verify that the user's request is authorized. If the user's request is not authorized, the processor (302 or 303) sends a message to the user through the request receiver and router 301 and the communications server 250 informing the user that the request is denied. The processor (302 or 303) then logs the event with the system administrator 500. If the request is authorized, the processor (302 or 303) formats the request as necessary and routes content download requests to the content acquisition server 400 and search requests to the search engine server 350.

For programming download requests, the content acquisition server 400 submits scheduling and availability information about the selected content to the database administrator 502 within the system administrator 500, which in turn routes this scheduling and availability information to a scheduled program and content availability prompt and notification processor 306 within the request and results processing server 300. The scheduled program and content availability prompt and notification processor 306 then initiates a form of prompt and/or notification to the user that the selected content is available at a particular time. This notification can be in various forms including, but not limited to, an on-screen pop-up window, audible notification, e-mail notification, instant message, and automated telephone notification. The exact form and timing of the prompt and/or notification may be customized by the user and may be based on whether the content is scheduled, continuously broadcast, stored, or available any time for download. In an embodiment, when a selected program is about to be broadcast or made available for viewing on television, a prompt will be sent by the server 300 notifying the user when the program is about to air. In the case of an on-screen prompt, a mechanism may be provided for enabling the user to hyperlink to the selected program from the prompt. For search requests, the search engine server 350 returns a data package to the request and results processing server 300 that contains scheduling, availability, and descriptive information about all content entries that have been determined to satisfy the search criteria.

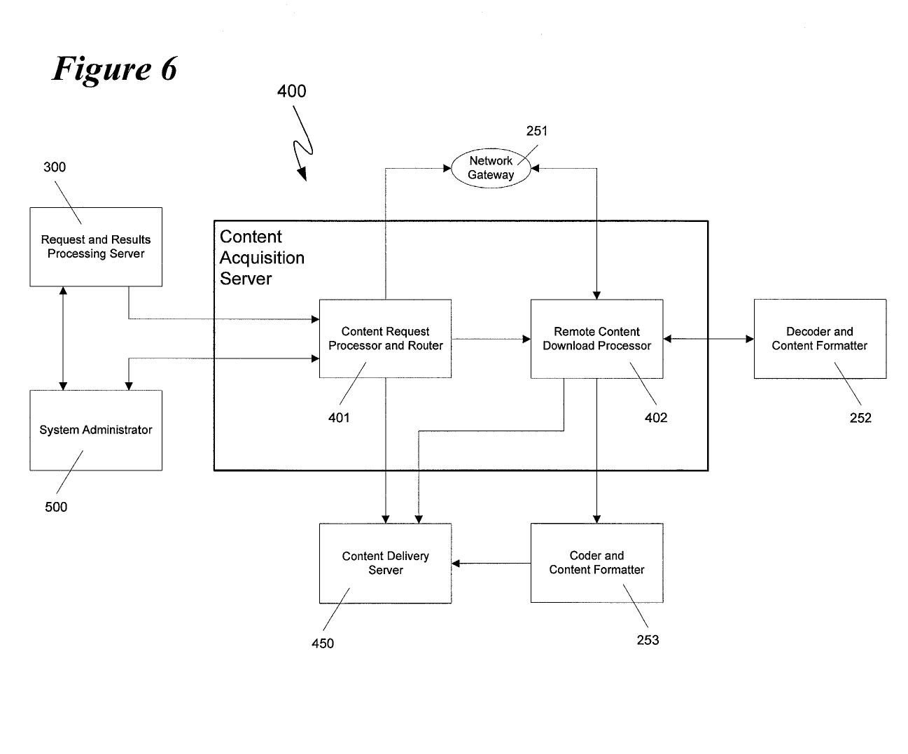

In addition to searching for content containing criteria entered by a system user, a content search suggestion engine 304, in conjunction with the search engine server 350 will be able to suggest content to the user that is related in various ways, such as by category or theme. The content search suggestion engine 304 is shown in detail in FIG. 6. For example, if a user wishes to see programs about Titanic, the content search suggestion engine 304 may, in addition to suggesting programs about Titanic, suggest or inform the user of programs and other content such as electronic books about ships other than Titanic. Likewise, if the search criteria include Johnny Weismuller, an actor who starred in Tarzan movies, the content search suggestion engine 304 might suggest programs and other content about Tarzan featuring someone other than Johnny Weismuller. Furthermore, the content search suggestion engine 304 may suggest programs for viewing based on past search criteria entered by the user as well as information on content the user has actually downloaded. For example, if the search criteria includes Johnny Weismuller and the user has searched and/or downloaded numerous sports-related programming in the past, the content search suggestion engine 304 may suggest programming and other content including swimming competitions and sports history and biography programming as well as Tarzan movies and other content directly related to Johnny Weismuller such as the Jungle Patrol television series. If the user searched for and received Tarzan movies, the content search suggestion engine 304 might suggest electronic books by Edgar Rice Burroughs. Such electronic books could then be downloaded to the user terminal 202 using the wide area network/Intranet 205 bypassing the aggregator 201, or could be compiled at the aggregator 201 for delivery to the user terminal 202. Electronic book delivery systems are described in U.S. Pat. No. 5,986,690, entitled “Electronic Book Selection and Delivery System,” to Hendricks, and in co-pending patent application Ser. No. 09/289,957, entitled “Electronic Book Alternative Delivery Systems,” and Ser. No. 09/289,956, entitled “Electronic Book Alternative Delivery Methods,” all of which are hereby incorporated by reference. The content suggestion function of the aggregator is described in more detail in co-pending patent applications entitled “Video and Digital Multimedia Aggregator” and patent application entitled “Video and Digital Multimedia Aggregator Content Suggestion Engine,” filed on Aug. 3, 2001, which are incorporated by reference.

Returning to FIG. 5, all search results, based on user search criteria and suggested search criteria, may be forwarded by the search engine server 350 and then to the search results form builder 305 within the request and results processing server 300. The search results form builder 305 formats the results for transmission through the communications server 250 to the user terminal 202. The search results form builder 305 takes prioritized lists of user search results and suggested search results and populates a search results form with programming, scheduling and availability information. The request and results processing server 300 then encrypts and forwards the search results form 674 through the communications server 250 to the user terminal 202. At the user terminal 202, the search results form 674 is decrypted and stored in the user local database 213 and a prompt is displayed that allows the user to display the returned results on the video display system 207 or the electronic book reader 230.

The search results can then be displayed on the user's video display system 207 in various formats including, but not limited to, a hierarchical listing based on relevance to search criteria and a display similar to an electronic program guide based on time of availability and content source. The user will be able to select from the various results display formats and have the results data be reformatted upon request. In an embodiment, the user may be able to select one of the search criteria or an attribute of the programming and the results will be sorted based on that selection. For example, if numerous program types are returned, the user can select “documentaries” and the results will be listed with documentary programs occurring first. The results display will also indicate whether a particular programming choice is a result of the user-defined search criteria or was a result of the system's capability to suggest content. The user will have the ability to display only results from the user search, only results from the suggested content search, or both. In an embodiment, the entire menu system can be implemented using audible prompts and lists in order to accommodate users with visual impairments. In such a scenario, input methods can be by voice recognition, tactile recognition such as a remote control equipped with a Braille character input pad, or a combination of these methods.

As shown in FIG. 4, the network gateway 251 serves as the communications system between the aggregator 201 and the wide area network/Internet 205, and hence the remote content server 204. The network gateway 251 may support any protocol in widespread use for connection to the wide area network/Internet 205 and may also serve as a security firewall between the aggregator 201 and the wide area network/Internet 205. The network gateway 251 will route search and content download information from the aggregator 201 to one or more remote content servers 204 and route search results and content from the remote content server 204 and other Internet sources back to the aggregator 201.

The content acquisition server 400, as shown in detail in FIG. 6, receives content download requests from the request and results processing server 300. The content acquisition server 400 includes a content request processor and router 401 and a remote content download processor 402. A download request is made by the user for content selections from sources including, but not limited to, earlier programming searches, recurring scheduled events, an electronic program guide, lists of electronic books and computer software, advertisements, promotions, and affiliated Internet websites. In general, a download request will be accompanied by data indicating the source of the content and whether the content is local or remote. Requests for content that is available only from a remote site may be routed to the network gateway 251 and then to the appropriate remote source. Remote sources include, but are not limited to, the remote content storage 258 and the remote streaming sources 259 shown in FIG. 4. The remote content server 204 verifies the request and returns the content through the wide area network/Internet 205. If the programming content is in the appropriate format and is authorized for direct delivery to the user, the content may be routed through the wide area network/Internet 205 and the wide area distribution system 203 directly to the user terminal 202. During this transfer, administrative data pertaining to billing and verification of delivery may be sent back to the aggregator 201.

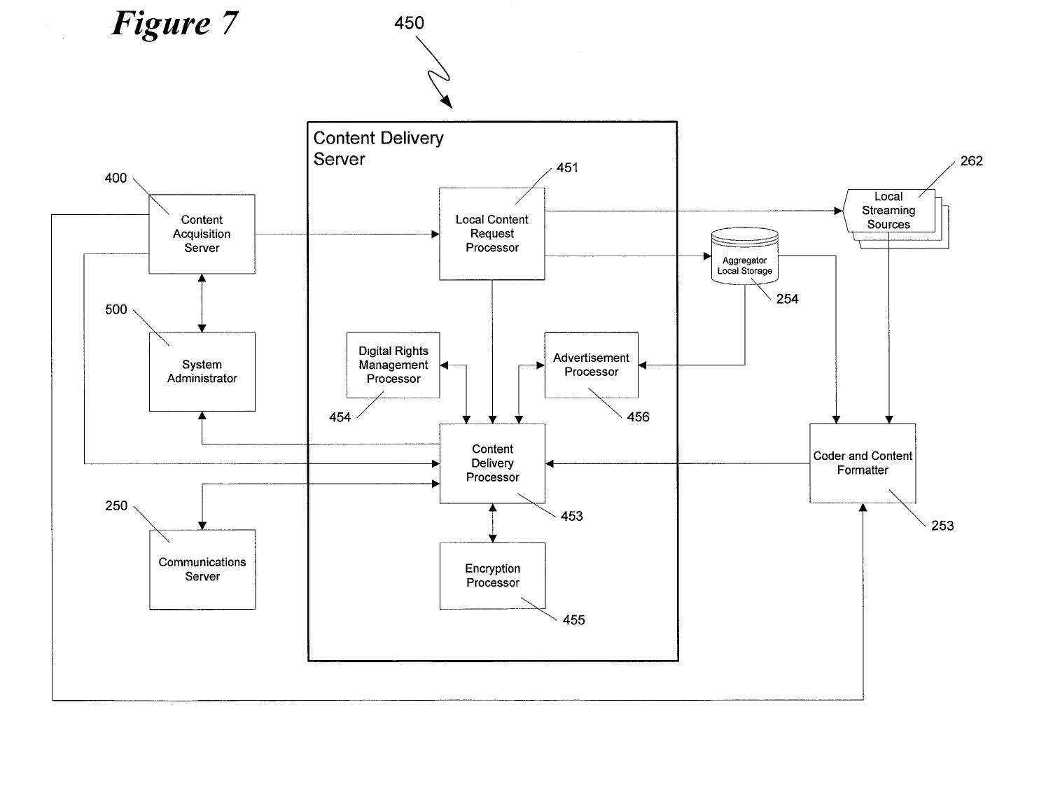

Programming that is not formatted and authorized for direct delivery from a remote source may be transmitted through the network gateway 251 to the remote content download processor 402 contained within the content acquisition server 400. The remote content download processor 402 buffers or caches the programming content while managing the download connection to the remote source. The programming content is then routed to the decoder and content formatter 252, which may be capable of decoding various industry formats and compression schemes and may reformat and encode the decoded data and associated metadata into one or more preferred content formats for delivery and for local storage. The processed programming content, along with user identification and routing data, is then routed to the content delivery server 450, which then manages the delivery of the content through the communications server 250 and wide area distribution system 203 to the user terminal 202. The content delivery server 450 is shown in detail in FIG. 7.

Requests for programming available from a local source are routed directly to a local content request processor 451 within the content delivery server 450. The local content request processor 451 initiates delivery of content from local sources including, but not limited to, the aggregator local storage 254 and aggregator local streaming sources 262, and routes the content to the coder and file formatter 253. In an embodiment, the local streaming sources 262 can include any of the cable television channels available at the cable television system headend 210 housing the aggregator 201. If the programming content is not already in the user-requested format and coding scheme, the coder and content formatter 253 (see FIG. 4) performs content formatting and coding of the programming for delivery to the user. The content is then forwarded to a content delivery processor 453, which manages the delivery of the content through the communications server 250 and wide area distribution system 203 to the user terminal 202.

During the content acquisition and delivery process, the content delivery processor 453 may oversee and validate that the delivered programming content matches the original content download request. This may be done by receiving program and user metadata from the content acquisition server 400 through the local content request processor 451 and comparing the received data to the metadata of the actual requested content and the actual delivered content as received during the program request and download process. A confirmation may then be logged with the system administrator 500. In an embodiment, based on user information and content metadata, the content delivery processor 453 may command an advertisement processor 456 to insert specific advertising into certain programming content as it is delivered to a system user. The advertising can be retrieved from the aggregator local storage 254 or can already be resident at the user terminal 202. Methods for targeting advertisements to users are described in co-pending patent applications Ser. No. 09/054,419, entitled “Targeted Advertising Using Television Delivery Systems,” and Ser. No. 08/160,280, entitled “Method and Apparatus for Targeted Advertising,” both of which are hereby incorporated by reference. Confirmation of the programming delivery is also sent to the database administrator 502 for logging into the aggregator local database 501.

Similarly, if content is copyright protected and the user is granted certain rights and denied others for use of copyright protected content, the content delivery processor 453 may command a digital rights management processor 454 to implement a digital rights management (DRM) scheme. The DRM scheme controls how digital content is used, including, but not limited to, whether or not the content can be stored on the user terminal 202, copied to another system, forwarded to another user, transferred to removable media, or translated into a different digital file format or coding scheme. The DRM scheme may be able to make use of digital encryption technology to enforce copyright protection if necessary. When this is the case, the digital rights management processor 454 will command the content delivery processor 453 to route the subject programming content along with encryption data to an encryption processor 455. The encryption processor 455 encrypts the programming content and returns the content to the content delivery processor 453 for transmission to the end user. Under this type of scenario, the authorized user terminal 202 will possess the necessary information to decrypt and output the programming content. The user terminal 202 will also contain the necessary information to enforce any DRM scheme that has been applied to a particular piece of content.

During the delivery of programming content other than broadcast programming over the concatenated cable television system 216, the user terminal 202 may continuously respond to the content delivery processor 453 identifying the user terminal 202, verifying that the appropriate data is being delivered, and indicating that the delivery should continue. If the download is terminated by the user, the user terminal 202 may inform the content delivery processor 453, which then terminates the delivery.

Upon successful delivery of the requested programming, the content delivery server 450 logs the results with a customer billing server 506 and content fee and copyright billing server 507 within the system administrator 500 (not shown in FIG. 4). The customer billing server 506 determines if the content delivery requires additional charges to the customer's account and enters this into the billing record and logs it with a database administrator 502 (see FIG. 8). The system administrator is described in more detail in co-pending patent application entitled “Video and Digital Multimedia Aggregator,” filed on Aug. 3, 2001, which is incorporated by reference.

The system user can initiate content search requests by entering several different types of search criteria using several different options of input device or method. Search criteria can be entered via keywords that relate to certain aspects of programming content including, but not limited to, subject, author, title, cast members or performers, director, and/or content description. A search can be based on program type or format including, but not limited to, movies, television series, documentaries, sports programs, talk radio, and music radio. The user may input search criteria based on subject categories including, but not limited to, action, drama, history, educational, juvenile, adult, current events, nature, live events, and music categories such as classical, jazz, rock, consumer affairs, political content, and geographically specific content. Search criteria can also be entered based on time of day, channel, and/or content provider. The user may also input free form questions using plain speech patterns. In any case, the different search criteria can be used separately or in conjunction with one another to refine a content search. An example might be the entry of “Titanic” as a keyword, “Documentary” for program type, and the free form question “What company built Titanic?”.

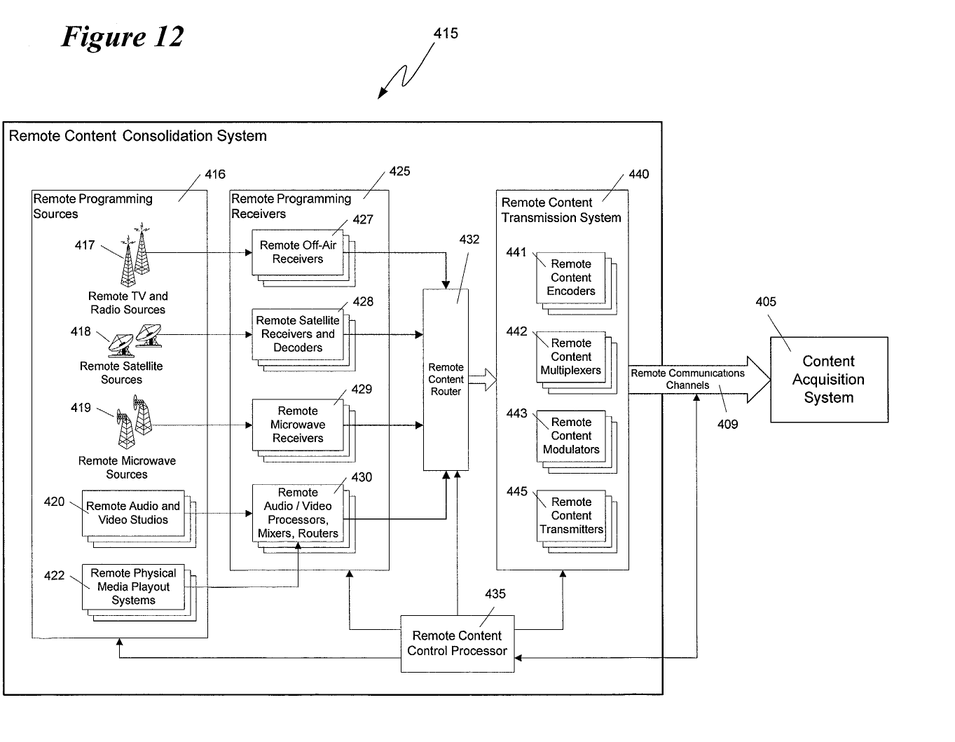

The user can interact with the user terminal 202 to input search parameters using one or more of several user input devices 214 including, but not limited to, those shown in FIG. 12. The user input device 214 includes a keyboard 220, a keypad 221, a mouse or joystick 222, a handheld computer 223, a touch screen tablet 224, a handheld remote control 225, a user terminal voice recognition system 219, an input device voice recognition system 226, and an electronic book reader 230.

Since programming content can be delivered in more than one way, the user may also consume the programming in more than one way. Audio and/or video content may be viewed and/or listened to concurrently with the delivery in the case of a broadcast delivery over the cable television system as well as during an Internet delivery of a data stream or file that contains the programming. The user can also store the content as the content is delivered, whether or not the user consumes the content during the delivery, allowing for non-linear playback of content at the user terminal 202 either during delivery or at a later time. Non-linear playback refers to the ability of a user to stop, start, pause, rewind, slowdown, and speedup the playout of a piece of video or audio content. In an embodiment, programming is delivered from the system 200 in less time that it would take to consume the programming and is saved in user local storage 212 for use at any time thereafter. In the case of a real-time broadcast, the storage method may be onto magnetic tape using an audio/video recording system 209 such as a video cassette recorder, or into user local storage 212 as a digital file such as onto a computer hard disk drive or other digital data storage medium. Once the user has numerous programs stored in the user local storage 212, the user terminal 202 will provide the ability for the user to manage content storage and organization through a series of simple GUIs approximating an audio-video library collection. Storage management may also be automated using either user-defined or pre-set rules, or both. (See DAVIC 1.5 Specifications, TV Anytime and TV Anywhere, Revision 6.0; copyright Digital Audio-Visual Council (DAVIC), hereby incorporated by reference, for more detail about concurrent viewing and storing, non-linear playback, non-real-time delivery, and content storage and management.)

In an embodiment, the user terminal 202, whether it is comprised of a set top terminal 206, a personal computer terminal 211, or some combination thereof, is integrated into a home network 229 serving the user's home. This will enable the consumption of programming content at numerous nodes in the home which may consist of auxiliary user terminals and/or personal computers with various combinations of video display system 207, audio playout system 208, and audio/video recording system 209. The primary user terminal 202 can route programming search and download requests from other network nodes and route subsequent downloaded programming to the requesting node either an a baseband video network or a digital data network such as an Ethernet network. Auxiliary nodes may also have a combination of user input devices 214 to control the system and initiate programming requests and downloads. In an embodiment, a handheld remote control 225 using wireless radio frequency transmission may control the primary user terminal 202 from a remote location to deliver programming to a remote video display system 207.

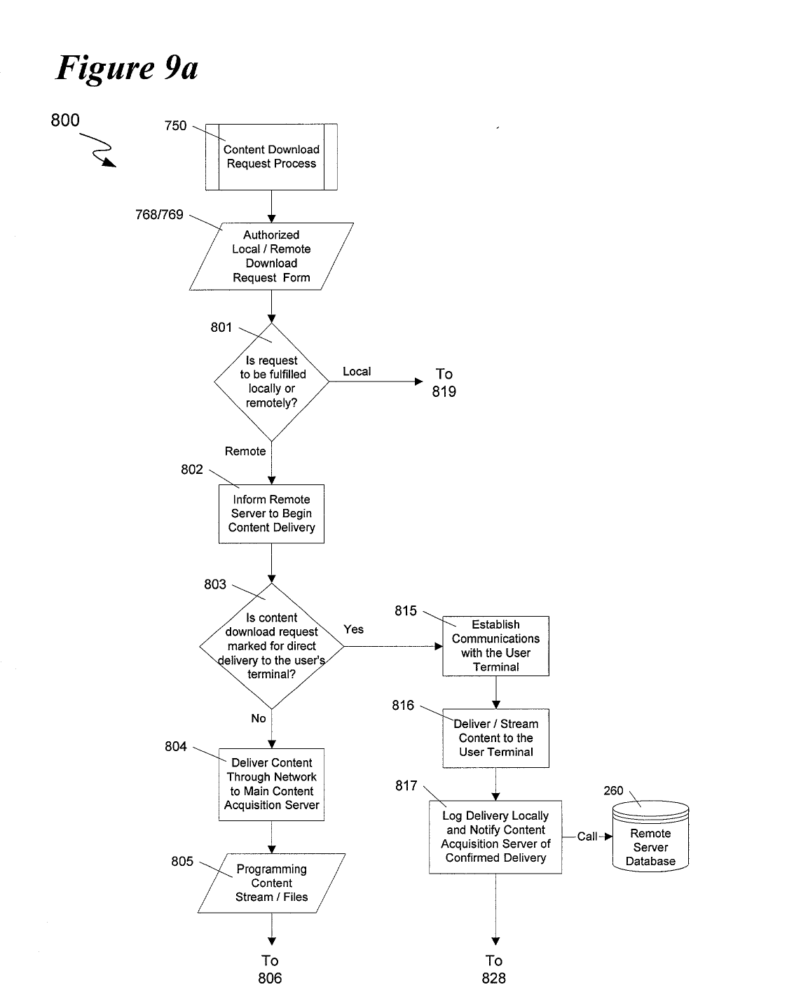

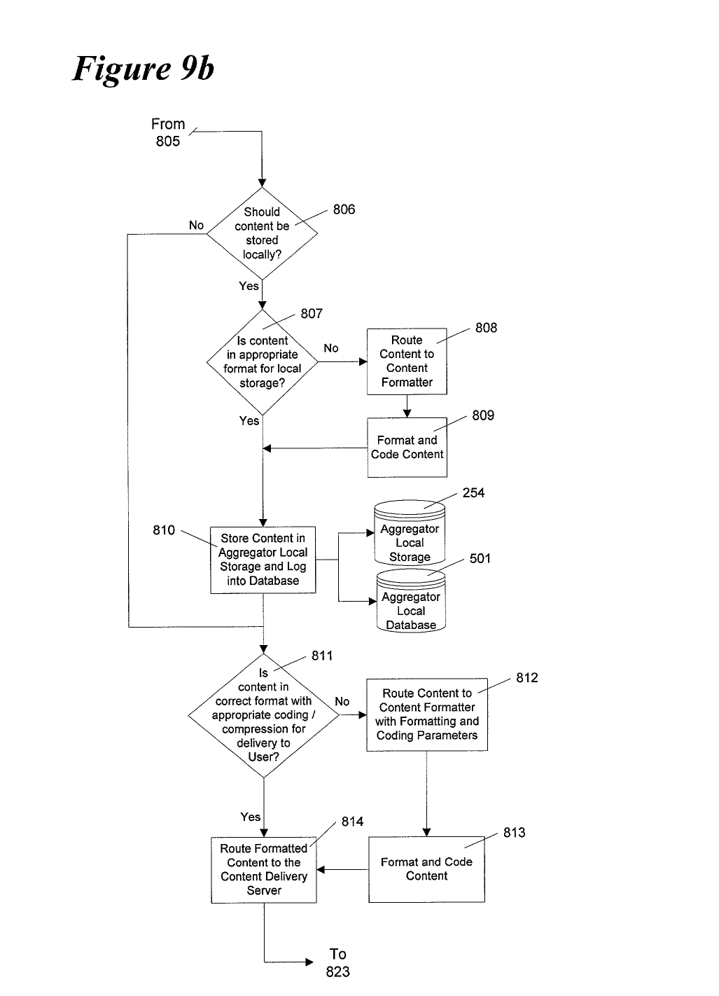

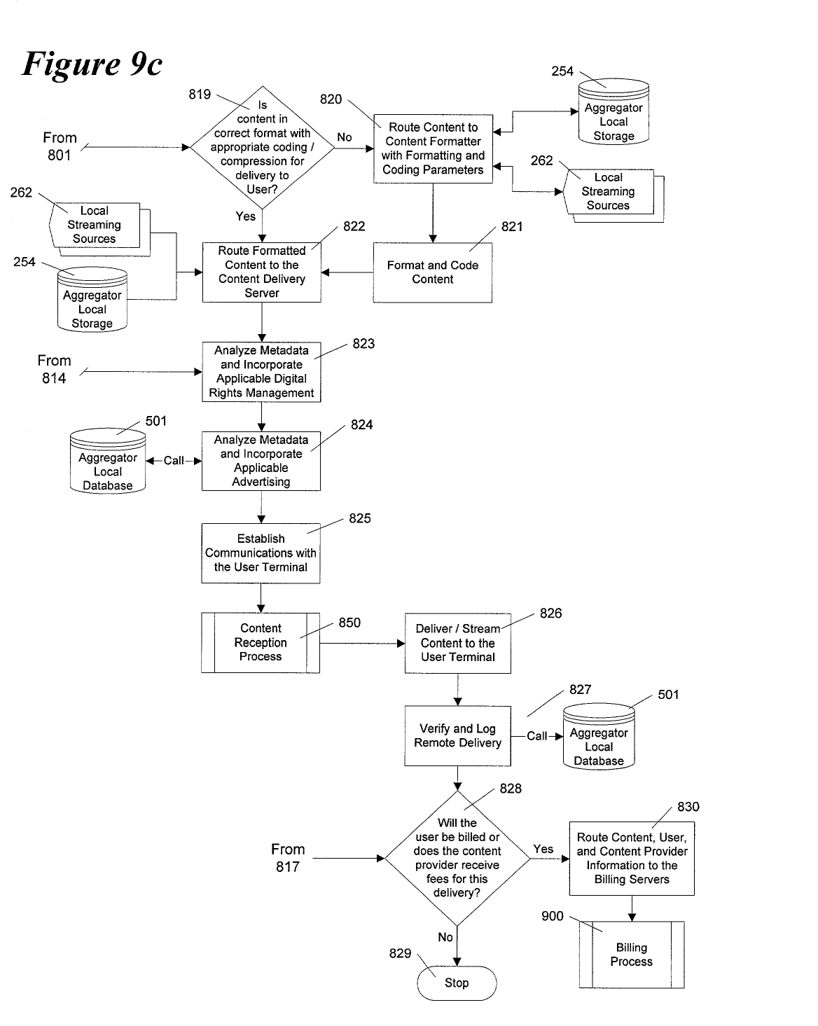

Once a download request has been processed and authorized, the content download request process creates either an authorized remote download request form 768 or an authorized local download request form 769 and forwards the authorized download request to the content delivery server 450, which fulfills delivery of the content using the basic content delivery process 800 shown in FIGS. 9A, 9B and 9C. As an authorized remote download request form 768 or an authorized local download request form 769 is received, the content delivery server 450 determines, routine 801, if the request is local or remote, and routes the request form appropriately (routine 802 for a remote request and routine 819 for a local request).

If the request is to be fulfilled remotely, execution of the routine 802 transmits a message to the remote content server 204 to begin delivery of the programming content. In routine 803, the download request is analyzed and the remote content server 204 determines if the content can be delivered directly to the user without going back through the aggregator 201. If the content is not designated for delivery directly to the user, routine 804 is executed, which establishes a communications link with the main content acquisition server 400 through the network gateway 251 and starts transmitting the requested programming. In the case of programming that is airing in real-time, the programming can be in the form of an audio/video stream from various remote streaming sources 259. Non-real-time programming can be in the form of compressed audio/video files delivered from remote content storage 258. When the content delivery process commences, execution of routine 806 initiates a process in the system administrator 500 that analyzes the content metadata and determines if the programming should be stored at the aggregator local storage 254. The system administrator 500 may determine to store a particular program locally based on reasons including, but not limited to, the program being a live event such as a sports event or a musical concert that will likely be requested for download in the future. Alternatively, the programming is not stored locally and the current request represents a predetermined number of users that have requested the content requiring remote delivery.

If the programming being delivered from a remote content server 204 will be stored to the aggregator local storage 254, the programming metadata is analyzed (routine 807) to determine if the content is in an acceptable format for local storage. The aggregator 201 may be configured to store content in one or more specific formats that will balance the highest quality of programming content to be delivered to the users versus available storage space. In an embodiment, one or more of the selected storage formats will make the most efficient use of the aggregator local storage 254 resources as well as support high-speed delivery to system users. If the content is determined to meet the format requirements for local storage, processing passes on to routine 810. If the content does not meet the format requirements, the content stream and/or files are routed to the decoder and content formatter 252, routine 808. At routine 809, the decoder and content formatter 252 decodes the incoming data and may extract digital and/or analog data representing the content and its metadata. The decoder and content formatter 252 then reformats the content into the required formats and coding schemes for local storage. Upon execution of storage routine 810, the properly formatted programming content is stored to the aggregator local storage 254. The process and the new location of the content is then logged into the aggregator local database 501.

Whether or not the content was stored locally, routine 811 analyzes the programming content's metadata and determines if the content is in the appropriate format and coding scheme for delivery to the user. The format and coding scheme for delivery may be different from that used for local storage in order to accommodate particular parameters of a user's download request. The user may request specific formats and coding schemes due to considerations including, but not limited to, the method of playback, the type of programming, whether the user intends to store the content, or the type and bandwidth of the connection the user terminal 202 has to the aggregator 201 or the remote content server 204. If the content is determined to meet the format requirements for delivery to the user, processing moves to routine 814. If the content does not meet the format criteria, the content stream and/or files are routed to the decoder and content formatter 252 by (routine 812) along with the required formatting and coding parameters. At routine 813, the decoder and content formatter 252 decodes the incoming data and may extract digital and/or analog data representing the content and its metadata. The decoder and content formatter 252 then reformats the content into the required formats and coding schemes for delivery to the user. Processing then moves to routine 823 for delivery, which is discussed below when that processing path becomes common to both remote and local content delivery.

Returning to block 803 in FIG. 9A, if the programming content is designated for direct delivery to the user's terminal, the remote content server 204 establishes a communications link with the user terminal 202 (routine 815) and delivers the content files or streams the broadcast program directly to the user terminal 202 (routine 816). After the completed delivery is validated during routine 816, routine 817 logs the delivery fulfillment in the remote server database 260 and notifies the content acquisition server 400 at the aggregator 201 that the requested programming content has been successfully delivered to the user. Processing is then moved to the system administrator 500 (routine 828), which is discussed below, when that processing path becomes common to each delivery type.

If the programming download request is to be fulfilled by the local aggregator 201, execution of the routine 801 passes processing to routine 819 in the local content request processor 451 of the content delivery server 450, which analyzes the programming content's metadata and determines if the content is in the appropriate format and coding scheme for delivery to the user. If the content is determined to meet the format requirements for delivery to the user, processing moves to routine 822. If the format and coding scheme is not correct, execution of the routine 820 retrieves the programming content from the aggregator local storage 254 or the appropriate local streaming sources 262 and routes the programming to the decoder and content formatter 252 along with the required formatting and coding parameters. In routine 821, the decoder and content formatter 252 decodes the incoming data and may extract digital and/or analog data representing the content and its metadata. The decoder and content formatter 252 then reformats the content into the required formats and coding schemes for delivery to the user. Execution of routine 822 takes the correctly coded and formatted programming content file(s) and/or streams, whether directly from local sources or from the decoder and content formatter 252, and routes this content to the content delivery server 450.

Whether the programming content is being delivered by the local aggregator 201 from a remote source or a local source, upon execution of routine 823, the content delivery server 450 analyzes the user's profile information and the content metadata and, if applicable, instructs the digital rights management processor 454 to apply the appropriate DRM scheme to the content delivery. If the DRM scheme involves encrypting the programming content for delivery, the programming content is routed to the encryption processor 455, which processes the digital content data through an encryption algorithm using the appropriate user encryption key and routes the encrypted data back to the content delivery server 450.

The content delivery server 450 then analyzes the metadata and user information, routine 824 and, if applicable, instructs the advertisement processor 456 to incorporate any advertising into the delivery that is appropriate. The advertising is then retrieved from the aggregator local database 501 and packaged with the programming content delivery. In an embodiment, the advertisement processor 456 may have already delivered particular advertising to the user terminal 202 for storage, and having determined this from the user data, may insert a placeholder for an advertisement that will instruct the user terminal 202 to retrieve and display the advertisement at the appropriate time.

Upon execution of routine 825, the content delivery server 450 instructs the communications server 250 to establish a communications link with the user terminal 202 through the wide area distribution system 203, initiating a content reception process 850. The content delivery processor 453 delivers the content to the user terminal 202 (routine 826) through the communications server 250 and wide area distribution system 203. Execution of routine 827 verifies the correct delivery of the programming content to the user, and when the delivery is complete, logs the successful delivery with the system administrator 500. The delivery of content may be done in real-time in the case of broadcast programs and live or scheduled program streams or can be done in non-real-time where the content may be delivered at a rate higher or lower than that required for real-time viewing and is stored by the user terminal 202 for playback at a time chosen by the user. (See DAVIC 1.5 Specifications, TV Anytime and TV Anywhere, Revision 6.0; copyright Digital Audio-Visual Council (DAVIC), hereby incorporated by reference, for more detail about concurrent viewing and storing, non-linear playback, non-real-time delivery, and content storage and management.)

Whether the programming was delivered by the local aggregator 201 or by a remote content server 204, processing moves to routine 828 in the system administrator 500, which analyzes the user profile and the content metadata to determine whether the user will be billed or if the content provider is due a fee for the content delivery. If no bills are due, processing ends, routine 829. If billing or fees are applicable, routine 830 routes user information, appropriate content metadata, and content provider information to the system administrator 500, which enters this data into the billing process represented by routine 900.

Prior to content delivery, the programming content may be processed by the coder and content formatter 253 if required to deliver the content in an appropriate digital coding scheme, compression, and file format to the user. The coder and content formatter 253 employs digital compression techniques to increase existing transmission capacity. A number of digital compression algorithms currently exist or may be developed in the future that can achieve the resultant increase in capacity and improved signal quality desired for the system 200. The algorithms generally use one or more of three basic digital compression techniques: (1) within-frame (intraframe) compression, (2) frame-to-frame (interframe) compression, and (3) within carrier compression or a combination of two or more techniques. The coder and content formatter 253 of the content search, packaging, and delivery system 200 may be able to use any one or combination of two or more of these techniques in addition to being able to have its capabilities modularly expanded to include any emerging and future techniques that are determined to be desirable.

In an embodiment, although a single digital compression standard may be used for the delivery system 200, different levels of compression can be utilized when delivering programs to a user requesting a particular program. For example, if the program is sent out using an HDTV format, then less compression is used as opposed to sending out the program using a standard video format. The reason is that the HDTV format requires more digital data per portion of content. Since the HDTV format requires more digital data, it will also require more bandwidth to transmit, possibly increasing the cost of delivery. Therefore, the quality of the video delivered may be a variable in the fees charged to users of the system 200.

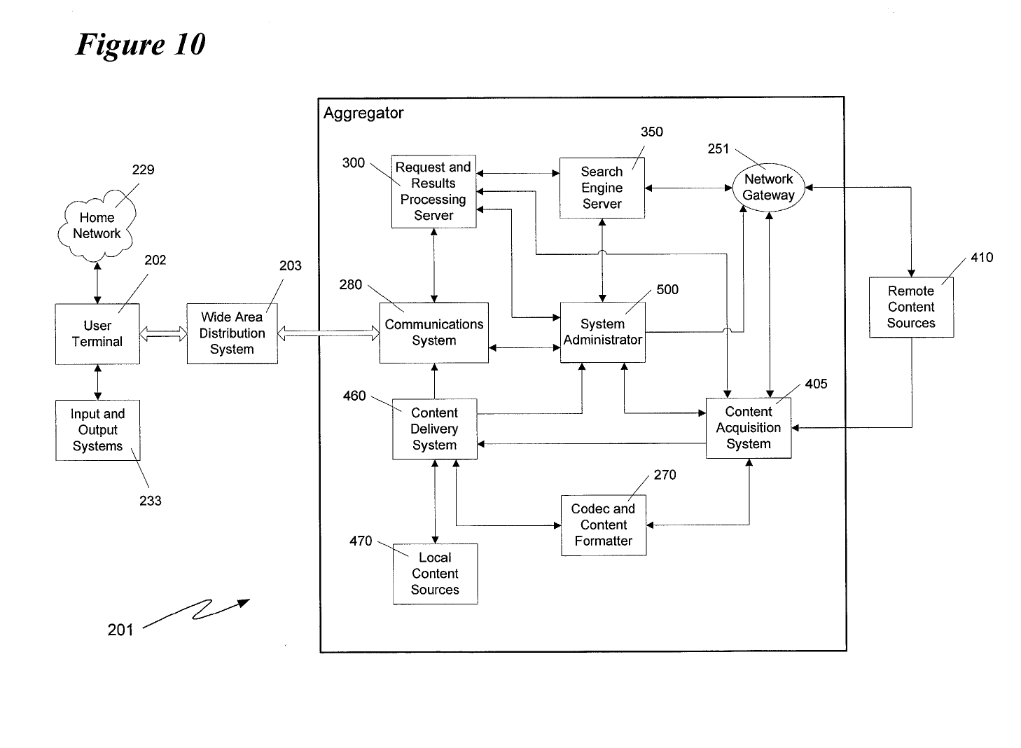

FIG. 10 shows the component systems of an alternate embodiment of the aggregator 201 that emphasizes the content acquisition and content delivery functions of the content search, packaging, and delivery system 200. In this embodiment of the aggregator 201, acquisition of remote content is executed by a content acquisition system 405 and delivery of content to system users is accomplished by a content delivery system 460 operating in conjunction with the communications system 280. Also in this embodiment of the aggregator 201, the one or more remote content servers 204 and remote databases 261 connected through the wide area network/Internet 205 to the network gateway 251 (see FIG. 4) may be included in the remote content sources 410. The aggregator local storage 254 and local streaming sources 262 may be included in the local content sources 470. Although not shown in FIG. 10, the user terminal 202 comprises one or more of a user terminal processor 227, a tuner 228, a demultiplexer 231, user local storage 212, and user local database 213 (see FIG. 4). The user terminal 202 may be coupled to a home network 229 and to input and output systems 233 comprising user input devices 214, a video display system 207, and audio playout system 208, and audio/video recording system 209, and an electronic book reader 230 as shown in FIG. 4. The decoder and content formatter 252 and the coder and content formatter 253 shown in FIG. 4 may be similar or identical in functionality, software configuration, and/or hardware configuration. In an embodiment, the decoder and content formatter 252 and the coder and content formatter 253 may be embodied by a single subsystem represented by a codec and content formatter 270 as shown in FIG. 10. In another embodiment, the decoder and content formatter 252 and the coder and content formatter 253 may each comprise one or more separate codec and content formatters 270.

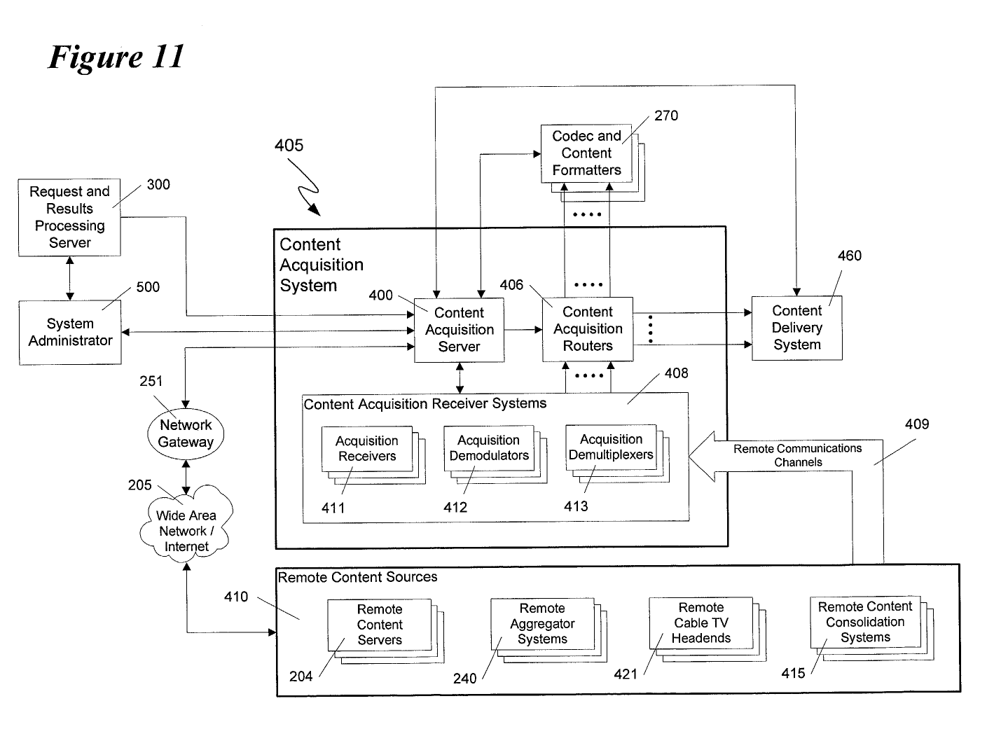

FIG. 11 shows the components of the content acquisition system 405, which may comprise the content acquisition server 400, one or more content acquisition routers 406, and one or more content acquisition receiver systems 408. FIG. 11 also shows components with which the content acquisition system 405 interacts as part of the content search, packaging, and delivery system 200. The one or more content acquisition receiver systems 408 may further be comprised of one of more acquisition receivers 411, acquisition demodulators 412, and acquisition demultiplexers 413. The content acquisition server 400 may comprise the same components as shown in FIG. 6 and may perform the same functions as described earlier in reference to FIG. 6 with the addition of interfacing with and controlling one or more content acquisition routers 406, one or more components of the content acquisition receiver systems 408, and communicating with a content delivery system 460 and one or more remote content source 410 systems. Content may be obtained from other similar aggregator systems connected to the wide area network/Internet 205 and/or through one or more of various remote communications channels 409 and are designated as remote aggregator systems 240, as shown in FIG. 11. Also, as described earlier, the content acquisition server 400 may acquire content from remote content servers 204 through the network gateway 251 connected to the wide area network/Internet 205 and/or through one or more of various remote communications channels 409. Another remote source of content may be one or more remote cable television headends 421 that may consolidate various programming content sources and that may be connected to the content acquisition receiver systems 408 through a coaxial cable system or other appropriate means that may comprise one or more of the remote communications channels 409. The remote content sources 410 may comprise one or more remote consolidation systems 415, remote content servers 204, remote aggregator systems 240, and remote cable television headends 421.

The content acquisition receiver systems 408 receive remote content from one or more remote content consolidation systems 415 through one or more remote communications channels 409 and/or through the network gateway 251 and the wide area network/Internet 205. Receipt of remote content may be in response to content download requests transmitted by the content acquisition server 400 to one or more remote consolidation systems 415, one or more remote content servers 204, one or more remote aggregator systems 240, and/or one or more remote cable television headends 421. The remote communications channels 409 comprise various transmission paths and/or communications systems that may connect one or more content acquisition receiver systems 408 to one or more remote content sources 410. The remote communications channels 409 may include one or more, or a combination of two or more, microwave systems, satellite systems, optical systems, wide area network and/or Internet systems, coaxial cable systems, telephone systems, wireline systems, and/or wireless systems.

The remote communications channels 409 may comprise any communications infrastructure system capable of transmitting desired content from the remote content sources 410 to the content acquisition system 405 whether the content is analog and/or digital audio, analog and/or digital video, multimedia data, textual data, or other content types or formats that may be compatible with the content search, packaging, and delivery system 200. The remote communications channels 409 may connect the content acquisition system 405 to one or more remote content sources 410 and/or collections of remote content sources 410 that may be distributed over a wide geographic area. Any particular group of remote content sources 410 may contain only one of the indicated systems included in FIG. 11 or may contain any combination of two or more of the indicated systems. The systems supporting the remote communications channels 409 may be scalable in order to be able to support yet-to-be-developed transmission protocols and methods and may be assigned dynamically as required. Transmission of content requests and administrative data from the content acquisition server 400 to one or more remote content sources 410 may be through a channel supported by the network gateway 251 through the wide area network/Internet 205, as shown in FIG. 11, or may be through one or more control and data channels that may occupy the same transmission path as one or more of the remote communications channels 409. As an example, the content acquisition server 400 may receive a request from the request and processing server 300 for download of content available from one of the remote content consolidation systems 415 and transmit authorization and content identification information to the consolidation system 415 using an Internet connection. The consolidation system 415 may then fulfill the request by transmitting of the requested content data to the content acquisition receiver systems 408 through a remote communications channel 409 that may comprise a broadband transmission channel such as a satellite or fiber-optic communications link.

In addition to receiving content data from one or more remote content sources 410 based on specific user requests, remote content data may be transmitted to the content acquisition system 405 on a scheduled basis and/or a continuous basis. For example, each game played by a certain sports team may be scheduled for delivery to the content acquisition system 405 and/or a certain regional broadcast sports channel may be continuously transmitted to the content acquisition system 405.

The remote content servers 204, as described earlier and as shown in FIG. 4 and FIG. 11, may provide the content acquisition server 400 content data from remote streaming sources 259 and remote content storage 258 through the wide area network/Internet 205 and the network gateway 251. In addition, one or more remote aggregator systems 240 may provide content from various sources through the wide area network/Internet 205 and the network gateway 251. In an embodiment, the remote content servers 204 and remote aggregator systems 240 may provide content to the content acquisition receiver systems 408 using one or more digital protocols transmitted through one or more of the remote communications channels 409. In another embodiment, the remote content servers 204 may comprise one or more audio and/or video playout servers.

In FIG. 11, signals containing content that are received from remote sources by one or more content acquisition receiver systems 408 may be first sent to one or more acquisition receivers 411, which may receive the electronic signals from one or more communications channels and route these signals to one or more acquisition demodulators 412. The acquisition demodulators 412 may act on the received electronic signals in order to filter analog and/or digital content data streams from one or more modulated carriers using one or more modulation schemes. The demodulated signals may then be sent to one or more acquisition demultiplexers 413 that may separate elementary streams or individual channels of content data from one or more multi-channel streams. The content data streams may then be sent to one or more content acquisition routers 406 in order to be routed to one of more codec and content formatters 270 and/or the content delivery server 450 as required. The content acquisition server 400 may manage and control one or more of the subsystems of the content acquisition receiver systems 408. In an embodiment, two or more of the functions performed by components within the content acquisition receiver systems 408 may be performed within a single piece of equipment or group of equipment so that a discrete component may not be necessary to perform each step or function of the content reception process. The content acquisition server 400 may communicate with one or more of the subsystems of the content acquisition receiver systems 408 to identify and manage available receiver system 408 resources, configure receiver system 408 hardware and/or software parameters for reception, demodulation, and demultiplexing operations, and to transmit routing information and operational parameters necessary for the content acquisition receiver systems 408 to receive, demodulate, and demultiplex content from various sources. The content acquisition server 400 may also communicate with one or more content acquisition routers 406 in order to transmit routing connection parameters and paths for the transfer of content data between various subsystems of the content acquisition receiver systems 408 and the appropriate subsystems of one or more codec and content formatters 270 and/or the content delivery server 450 contained within the content delivery system 460.

The content acquisition server 400 may use one or more of the content acquisition routers 406 to dynamically establish logical and/or physical circuit connections for transmission of content data between the various subsystems shown in FIG. 11. A content acquisition router 406 may comprise one or more hardware systems and one or more software modules that may operate under the direction of the content acquisition server 400 to establish and manage the interconnections between subsystems required to transfer content in support of one or more receiving, demodulating, and/or demultiplexing operations. In FIG. 11, several of the interconnections between subsystems are shown as two connection lines and a series of dots between the two lines. This convention is used in several of the supporting drawings and indicates that at any time there may exist one or more connections or circuits between one or more of the connected subsystems and that between two connected subsystems the number of connections may vary. Each collection of connections or circuits may comprise one or more logical and/or one or more physical connections between software and/or hardware modules. Physical routing configurations, such as may be required for the transfer of analog content, may be achieved using one or more industry standard and/or custom components such as circuit switching devices, matrix switches, distribution amplifiers, signal splitters, input and output ports, and patch bays. Logical routing, such as may be required for the transfer of digital content, may be achieved using one or more digital packet transport protocols that may operate on one or more local area networks supported by the content acquisition server 400 and/or the system administrator 500 as part of the content search, packaging, and delivery system 200. In an embodiment, the functionality of the content acquisition routers 406 may be implemented by one or more subsystems and may be functionally and/or physically external to the content acquisition system 405 and may be a subsystem (not shown in FIG. 4) of the aggregator 201. In another embodiment, the functionality of the content acquisition routers 406 may be implemented by one or more subsystems and may be functionally and/or physically external to the aggregator 201 so that the aggregator 201 and its subsystems may connect to the content acquisition routers 406, or equivalent systems, through external interfaces (not shown in FIG. 4). The number of connections and the logical and physical routing paths of such connections both within the content acquisition system 405 and external to the content acquisition system 405 may be changed as required to accommodate a smaller or larger number of content pathways and to accommodate various source and destination combinations required at any given time. These pathways may be created or modified on a demand basis by the content acquisition server 400 and may be modified prior to and/or during a reception, demodulation, and/or demultiplexing operation as may be required.

If remote content received by the content acquisition system 405 is not in the appropriate format and/or coding scheme for delivery and/or storage, the content may be routed to the codec and content formatters 270 for appropriate processing. The codec and content formatters 270 are described in more detail in co-pending U.S. patent application entitled “Video and Digital Multimedia Aggregator Content And Coding Formatting,” filed on date herein. If remote content received by the content acquisition system 405 is in an appropriate format and/or coding scheme for delivery and/or storage, then the one or more remote content files and/or transport streams containing the remotely acquired content may be routed to the content delivery system 460 for delivery to end users and/or storage in the aggregator local storage 254 as appropriate.

A remote content consolidation system 415, shown in detail in FIG. 12, may receive and aggregate one or more of various content sources in a particular geographic region for transmission to one or more aggregator 201 systems based on system user requests, specific programming schedules, and/or identification or nature of the content source. In an embodiment, one or more content acquisition systems 405 may be connected through one or more various remote communications channels 409 to one or more geographically distributed remote content consolidation systems 415. The consolidation systems 415 may comprise various combinations of subsystems and components including one or more remote programming sources 416, one or more remote programming receivers 425, a remote content router 432, one or more remote content transmission systems 440 connected to one or more remote communications channels 409, and a remote content control processor 435. Numerous configurations of remote content consolidation systems 415 may exist with the subsystems and components of FIG. 12 depicting a representational collection and configuration of subsystems and components. “Consolidation system” is a generic term that may apply to any content collection and retransmission system that provides content to an aggregator 201 system. As a minimum, a consolidation system 415 may comprise one remote programming source 416 and one remote content transmission system 440 connected to a remote communications channel 409.

Remote programming sources 416 may include, but are not limited to, one or more remote television and radio sources 417, remote satellite sources 418, remote microwave sources 419, remote audio and video studios 420, and remote physical media playout systems 422. Remote programming receivers 425 may include, but are not limited to, remote off-air receivers 427, remote satellite receivers and decoders 428, remote microwave receivers 429, and remote audio/video processors, mixers, and/or routers 430. Depending on the number and types of remote programming sources 416 and remote programming receivers 425, a remote content consolidation system 415 may or may not make use of a remote content router 432 to route and distribute remote content signals from one or more remote programming receivers 425 to one or more components and/or subsystems of a remote content transmission system 440. In an embodiment, the consolidation system 415 may not require a separate content router 432, instead having the outputs of one or more remote programming receivers 425 connected directly to the inputs of one or more remote content transmission system 440 components. Also depending on the number and types of remote programming sources 416 and remote programming receivers 425, a remote content consolidation system 415 may make use of a remote content control processor 435 to configure and control various components and subsystems of the consolidation system 415. The remote content control processor 435 may be connected through one or more of the subsystems and/or components of the remote content transmission system 440 and one or more of the remote communications channels 409 to the content acquisition system 405 in order to exchange data concerning the content acquisition, consolidation, and transmission processes.

The remote content transmission system 440 may include, but is not limited to, to one or more remote content encoders 441, remote content multiplexers 442, remote content modulators 443, and remote content transmitters 445. The inputs of one or more components of the remote content transmission system 440 may receive one or more content files and/or content transport streams from the remote content router 432 and/or directly from one or more remote programming receivers 425. The outputs of one or more remote content transmitters 445 may be connected to one or more remote communications channels 409 for transmission to the content acquisition system 405 within an aggregator 201. The one or more remote content encoders 441 may operate on one or more content files and/or content transport streams to apply one or more proprietary and/or standard formatting and coding schemes. One or more remote content multiplexers 442 may then operate on two or more content signals to combine the signals into a single composite signal to be transmitted over a single channel carrier. One or more content signals, whether encoded and/or multiplexed, may then be operated on by a one or more remote content modulators 443 that modulate the content data signals onto one or more intermediate and/or carrier frequencies appropriate for transmission over one or more remote communications channels. One or more modulated content signals may then be routed through one or more remote content transmitters 445 for appropriate frequency conversion and/or amplification for injection onto one or more of the remote communications channels 409 that will carry the signal(s) to one or more content acquisition systems 405. In an embodiment, two or more of the functions performed by components within the remote content transmission system 440 may be performed within a single piece of equipment or group of equipment so that a discrete component may not be necessary to perform each step or function of the transmission system process.

Within the remote programming sources 416 shown in FIG. 12, the remote television and radio sources 417 may include one or more off-air radio and/or television broadcasts available in any of a large number of geographically diverse markets. The remote satellite sources 418 may include, but are not limited to, audio and/or video signals from content providers using one or more proprietary and/or standard formats such as the direct broadcast satellite (DBS) systems, digital audio radio services (DARS), as well as programming from one or more radio and television distribution services and networks, broadcast network satellite feeds, occasional use video feeds, and other signals distributed by satellite such as distance learning and/or public programming services. The remote microwave sources 419 may include one or more audio, video, and/or data services distributed via point-to-point microwave networks and may comprise single content signals such as a regional television signal or may comprise a multiplex of two or more analog and/or digital content source signals. The remote audio and video studios 420 may include one or more of various radio- and/or television-based studios as well as other audio and video studios that may provide one or more digital and/or analog content feeds. The remote studios 420 may include live on-site broadcasts such as sporting events and/or news event coverage. The remote physical media playout systems 422 may include various audio and/or video systems for playing back programming that resides on physical media including, though not limited to, magnetic tape, optical discs, vinyl records, movie film, and other yet-to-be-developed media for storage and playback of programming content. The content feeds from the remote audio and video studios 420 and from the remote physical media playout systems 422 may be sent to one or more remote audio/video processors, mixers, and/or routers 430 that may perform various processing functions on the audio and video signals of the source content to meet content requirements for transmission. The audio/video processing functions may include adjusting audio levels, combining and/or splitting audio and/or video signals, and adjusting video luminance and chrominance.

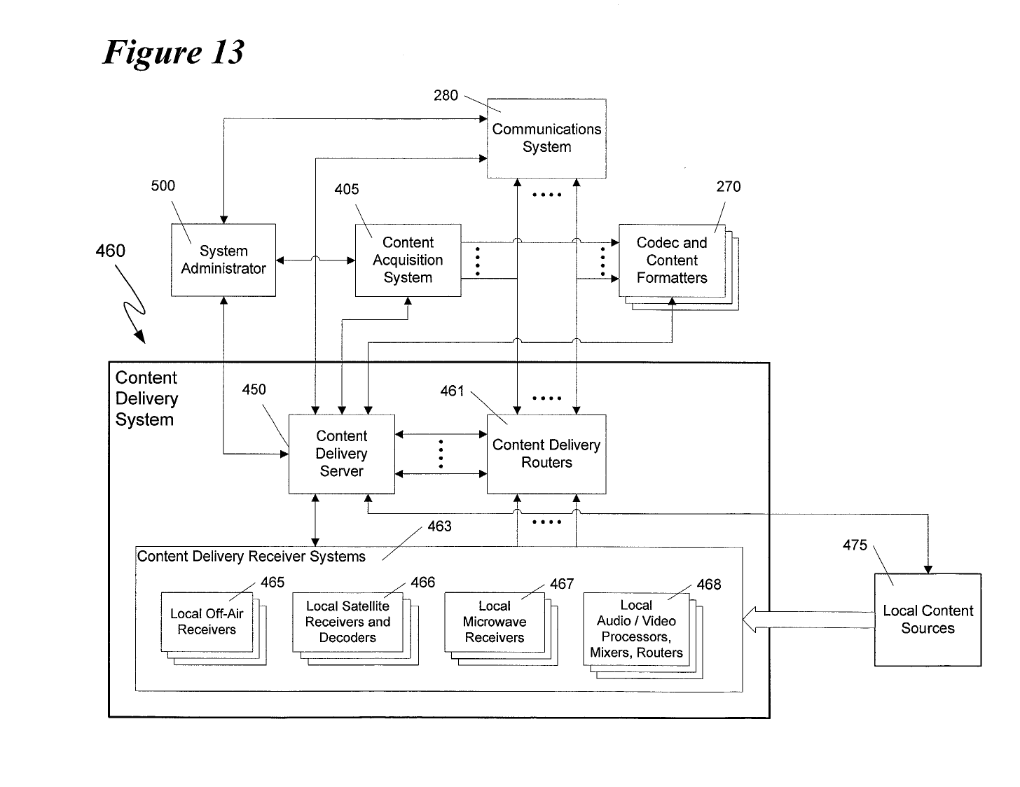

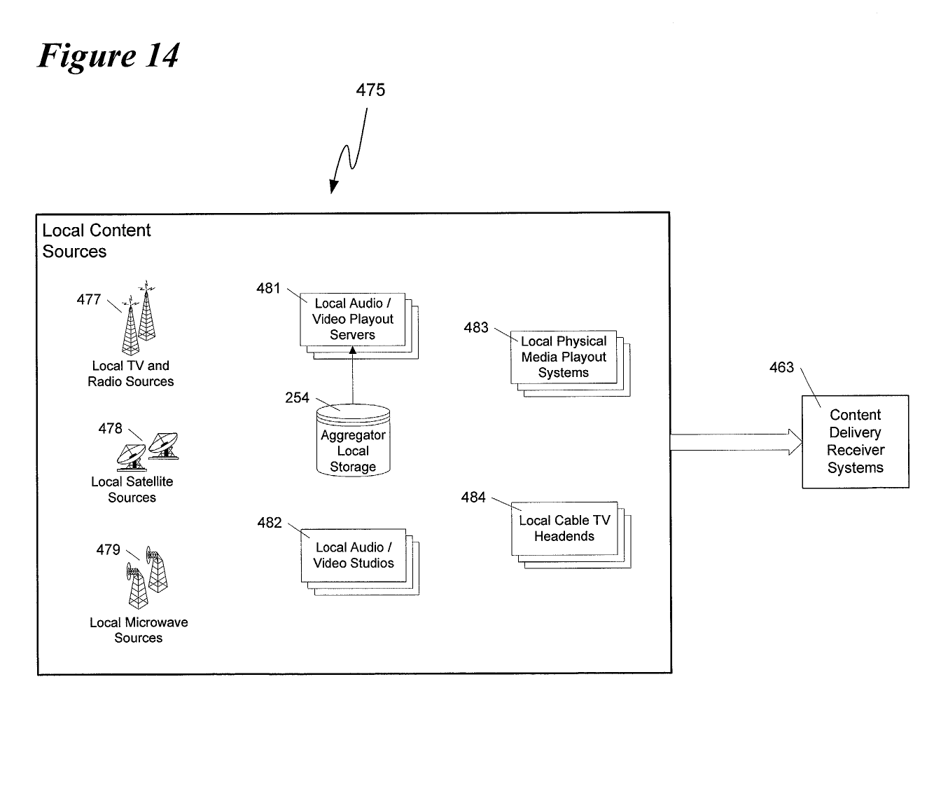

FIG. 13 shows the components of the content delivery system 460, which may comprise the content delivery server 450, one or more content delivery routers 461, and one or more content delivery receiver systems 463. FIG. 13 also shows components with which the content delivery system 460 interacts as part of the content search, packaging, and delivery system 200. The one or more content delivery receiver systems 463 may further comprise one or more local off-air receivers 465, local satellite receivers and decoders 466, local microwave receivers 467, and local audio/video processors, mixers, and/or routers 468. The content delivery server 450 may comprise the same components as shown in FIG. 7 and may perform the same functions as described earlier in reference to FIG. 7 with the addition of interfacing with and controlling one or more content delivery routers 461, one or more components of the content delivery receiver systems 463, and/or one or more components of the local content sources 475 shown in detail in FIG. 14.

In FIG. 13, signals containing content that are received from local content sources 475 by one or more content delivery receiver systems 463 may be operated on by one or more receiver systems 463 that may extract one or more baseband content files and/or data streams that may comprise audio, video, and/or other content capable of being delivered by the aggregator 201. The content data may then be sent to one or more content delivery routers 461 in order to be routed to one of more codec and content formatters 270, the content delivery server 450, and/or the communications system 280 as required. The content delivery server 450 may manage and control one or more of the subsystems of the content delivery receiver systems 463 and the local content sources. The content delivery server 450 may communicate with one or more of the subsystems of the content delivery receiver systems 463 to identify and manage available receiver system 463 resources, configure receiver system 463 hardware and/or software modules, and to transmit routing information and operational parameters necessary for the content delivery receiver systems 463 to receive, demodulate, demultiplex, and process content from various local content sources 475. The content delivery server 450 may communicate with one or more of the components of the local content sources 475 in order to identify and access the desired local content data, identify and manage available local content resources, configure local content source 475 hardware and/or software modules, and to transmit routing information and operational parameters. The content delivery server 450 may also communicate with one or more content delivery routers 461 in order to transmit routing connection parameters and paths for the transfer of content data between various subsystems of the content delivery receiver systems 463 and the appropriate subsystems of one or more codec and content formatters 270 and/or the communications system 280.

If local content accessed by the content delivery system 460 is not in the appropriate format and/or coding scheme for delivery, the content may be routed to one or more codec and content formatters 270 for appropriate processing. The codec and content formatters 270 are described in more detail in co-pending U.S. patent application entitled “Video and Digital Multimedia Aggregator Content And Coding Formatting,” filed on date herein. If local content accessed by the content delivery system 460 is in an appropriate format and/or coding scheme for delivery, then the one or more remote content files and/or transport streams containing the local content may be routed to the communications system 280 for transmission to one or more end users as appropriate.

One or more content files and/or content data streams to be delivered to one or more system users may be designated for processing by the content delivery server 450 to apply other services to the content data such as digital rights management, encryption, and/or advertising. Content designated for digital rights management processing, encryption, and/or addition of advertisement data may be routed by one or more content delivery routers 461 to the content delivery server 450 prior to routing to the communications systems 280 for deliver to system users. Within the content delivery server 450, these services may be incorporated with the content data as described earlier in reference to FIG. 7 by a digital rights management processor 454, an encryption processor 455, and/or an advertisement processor 456 and may be applied to content whether the content source is local or remote. After the application of designated services, the content delivery server 450 may then route the processed content data back to one or more content delivery routers 461 for forwarding to the communications system 280. The content delivery server 450 may incorporate metadata and/or other user information concerning applied services with the content data or in a separately transmitted file or data stream for forwarding to one or more user terminals 202 by the communications system 280.

The content delivery server 400 may use one or more of the content delivery routers 461 to dynamically establish logical and/or physical circuit connections for transmission of content data between the various subsystems shown in FIG. 13. A content delivery router 461 may comprise one or more hardware systems and one or more software modules that may operate under the direction of the content delivery server 400 to establish and manage the interconnections between subsystems required to transfer content in support of one or more receiving, demodulating, and/or demultiplexing operations. In FIG. 13, several of the interconnections between subsystems are shown as two connection lines and a series of dots between the two lines indicating that at any time there may exist one or more connections or circuits between one or more of the connected subsystems and that between two connected subsystems the number of connections may vary. Each collection of connections or circuits may comprise one or more logical and/or one or more physical connections between software and/or hardware modules. Physical routing configurations, such as may be required for the transfer of analog content, may be achieved using one or more industry standard and/or custom components such as circuit switching devices, matrix switches, distribution amplifiers, signal splitters, input and output ports, and patch bays. Logical routing, such as may be required for the transfer of digital content, may be achieved using one or more digital packet transport protocols that may operate on one or more local area networks supported by the content delivery server 450 and/or the system administrator 500 as part of the content search, packaging, and delivery system 200. The number of connections and the logical and physical routing paths of such connections may be changed as required to accommodate a smaller or larger number of content pathways and to accommodate various source and destination combinations required at any given time. These pathways may be created or modified on a demand basis by the content delivery server 450 and may be modified prior to and/or during a reception, demodulation, and/or demultiplexing operation as may be required.

As shown in FIG. 14, local content sources 475 may include, but are not limited to, one or more local television and radio sources 477, local satellite sources 478, local microwave sources 479, local audio and/or video playout servers 481 that may be connected to the aggregator local storage 254, local audio and video studios 482, and local physical media playout systems 483, and local cable television headends 484. As shown in FIG. 13, local content delivery receiver systems 463 may include, but are not limited to, local off-air receivers 465, local satellite receivers and decoders 466, local microwave receivers 467, and local audio/video processors, mixers, and/or routers 468. Within the local content sources 475 shown in FIG. 14, the local television and radio sources 477 may include one or more off-air radio and/or television broadcasts available in one or more markets that may be geographically adjacent to the aggregator 201 system. The local satellite sources 478 may include, but are not limited to, audio and/or video signals from content providers using one or more proprietary and/or standard formats such as the direct broadcast satellite (DBS) systems, digital audio radio services (DARS), as well as programming from one or more radio and television distribution services and networks, broadcast network satellite feeds, occasional use video feeds, and other signals distributed by satellite such as distance learning and/or public programming services. The local microwave sources 479 may include one or more audio, video, and/or data services distributed via point-to-point microwave networks and may comprise single content signals such as a regional television signal or may comprise a multiplex of two or more analog and/or digital content source signals. The local audio/video playout servers 481 may comprise computer-based systems that can access, on a demand or request basis and/or a scheduled basis, content that may be stored in the aggregator local storage 254. The playout servers 481 may retrieve content data from local storage 254 and may convert the stored data into one or more formats for delivery including, but not limited to, MPEG audio and/or video, internet protocol encapsulated audio and/or video, baseband audio and/or video, and DBS audio and/or video. The local audio and video studios 482 may include one or more of various radio- and/or television-based studios as well as other audio and video studios that may provide one or more digital and/or analog content feeds. The local studios 482 may include live on-site broadcasts such as sporting events and/or news event coverage. The local physical media playout systems 483 may include various audio and/or video systems for playing back programming that resides on physical media including, though not limited to, magnetic tape, optical discs, vinyl records, movie film, and other yet-to-be-developed media for storage and playback of programming content. The local cable television headend 484 may comprise any audio, video, and/or data services provided by a local cable television system in one or more different formats. The content feeds from the local audio and video studios 482, the local physical media playout systems 422, and/or the local cable television headend 484 may be sent to one or more local audio/video processors, mixers, and/or routers 468 (see FIG. 13) that may perform various processing functions on the audio and video signals of the source content to meet content requirements for transmission. The audio/video processing functions may include adjusting audio levels, combining and/or splitting audio and/or video signals, and adjusting video luminance and chrominance.

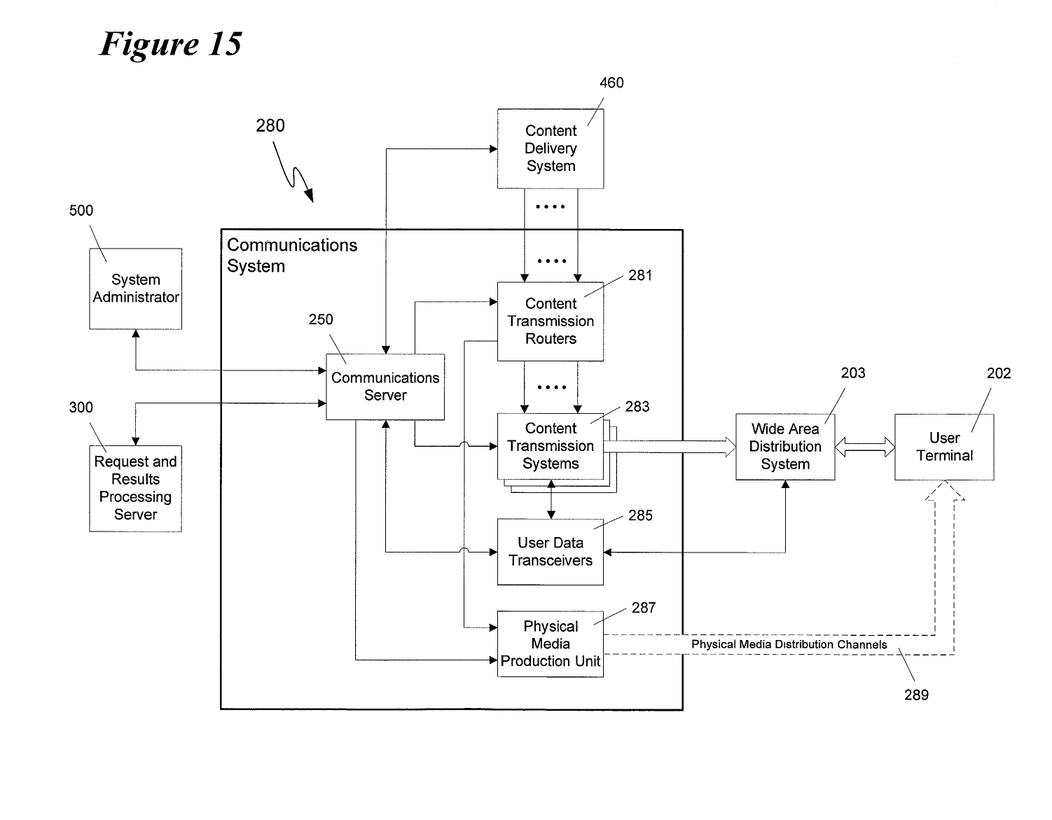

FIG. 15 shows the components of a communications system 280 which may be part of the alternate embodiment of the aggregator 201 shown in FIG. 10. FIG. 15 also shows components with which the communications system 460 interacts as part of the content search, packaging, and delivery system 200. Within the aggregator 201, the communications system 280 acts as the interface to the wide area distribution system 203 for the purpose of managing primary communications to system users. The communications system 280 may also interact with a request and results processing server 300, a content delivery system 460, and a system administrator 500. The communications system 280 may route incoming user search and download requests and associated user information to the request and results processing server 300, may route search results and content downloads through the wide area distribution system 203 to end users, and may route billing information to and from the customer billing server 506 within the system administrator to and from end users. The communications system 280 may receive content data files and/or content data transport streams from the content delivery system 460 and may transmit these content files and signals through the wide area distribution system 203 to one or more user terminals 202.

As shown in FIG. 15, the components of the communications system 280 may comprise the communications server 250, one or more content transmission routers 281, one or more content transmission systems 283, one or more user data transceivers 285, and a physical media production unit 287. The communications server 250 communicates with the content delivery system 460 to coordinate transfer of content data from the content delivery system 460 through one or more content transmission routers 281 to one or more content transmission systems 283 for delivery through the wide area distribution system 203 to one or more user terminals 202. Data transferred between the communications server 250 and the content delivery system 460 for coordination of content data transmission may include, but is not limited to, content routing parameters and addressing, content format metadata, content size and/or and duration metadata, identification and operational parameters for the target content transmission systems 283, identification and operational parameters for the one or more channels within the wide area distribution system 203 to be used for transmission, and identification and addressing information for the one or more user terminals 202 designated for reception of the content data.

The communications server 250 may use one or more of the content transmission routers 281 to dynamically establish logical and/or physical circuit connections for transmission of content data between the various subsystems shown in FIG. 15. A content transmission router 281 may comprise one or more hardware systems and one or more software modules that may operate under the direction of the communications server 250 to establish and manage the interconnections between subsystems required to transfer content from the content delivery system 460 to the content transmission systems 283. In FIG. 15, some of the interconnections between subsystems are shown as two connection lines and a series of dots between the two lines. This convention is used to indicate that at any time there may exist one or more connections or circuits between one or more of the connected subsystems and that between two connected subsystems the number of connections may vary. Each collection of connections or circuits may comprise one or more logical and/or one or more physical connections between software and/or hardware modules. Physical routing configurations, such as may be required for the transfer of analog content, may be achieved using one or more industry standard and/or custom components such as circuit switching devices, matrix switches, distribution amplifiers, signal splitters, input and output ports, and patch bays. Logical routing, such as may be required for the transfer of digital content, may be achieved using one or more digital packet transport protocols that may operate on one or more local area networks supported by the communications server 250 and/or the system administrator 500 as part of the content search, packaging, and delivery system 200. In an embodiment, the functionality of the content transmission routers 281 may be implemented by one or more subsystems and may be functionally and/or physically external to the communications system 280 and may be a subsystem (not shown in FIG. 4) of the aggregator 201. In another embodiment, the functionality of the content transmission routers 281 may be implemented by one or more subsystems and may be functionally and/or physically external to the aggregator 201 so that the aggregator 201 and its subsystems may connect to the content acquisition routers 281, or equivalent systems, through external interfaces (not shown in FIG. 4). The number of connections and the logical and physical routing paths of such connections both within the communications system 405 and external to the communications system 405 may be changed as required to accommodate a smaller or larger number of content pathways and to accommodate various source and destination combinations required at any given time. These pathways may be created or modified on a demand basis by the communications server 250 and may be modified prior to and/or during content transmission as may be required.

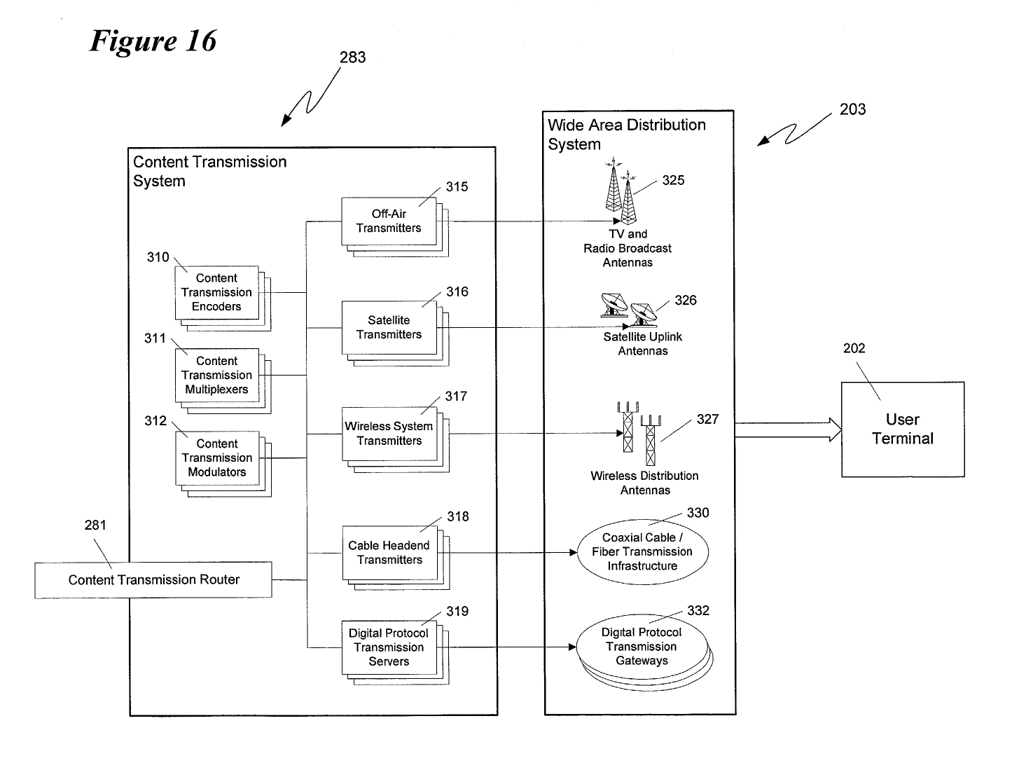

The communications server 250 may communicate with one or more components and/or subsystems within the content transmission systems 283 to identify and manage available content transmission resources, configure content transmission system hardware and/or software modules, and to transmit routing information and operational parameters necessary for the content transmission systems to multiplex, modulate, encode, process, and transmit content through a wide area distribution system 203 to one or more user terminals 202. As shown in more detail in FIG. 16, the outputs of the content transmission systems 283 may be coupled to various components and/or subsystems of the wide area distribution system 203. The wide area distribution system 203 may comprise various communications systems and/or transmission paths connecting one or more content transmission systems 283 to one or more user terminals 202. The wide area distribution system 203 may include one or more, or a combination of two or more, coaxial cable television systems, satellite systems, off-air broadcast channels, optical systems, wide area network and/or Internet systems, telephone systems, fiber systems, wireline systems, and/or wireless systems. The wide area distribution system 203 may comprise any communications infrastructure system capable of transmitting desired content from the communications system 280 within the aggregator 201 to one or more and user terminals 202 whether the content be analog and/or digital audio, analog and/or digital video, multimedia data, textual data, or other content types or formats that may be compatible with the content search, packaging, and delivery system 200.

FIG. 16 shows a representative content transmission system 283 and wide area distribution system 203. A content transmission system 283 may comprise one or more content transmission encoders 310, content transmission multiplexers 311, content transmission modulators 312, off-air transmitters 315, satellite transmitters 316, wireless system transmitters 317, cable head end transmitters 318, and digital protocol transmission servers 319. The one or more digital protocol transmission servers 319 may comprise computing systems that are capable of encapsulating content files and data streams into one or more standard and/or proprietary digital protocols for transmission over various cable, fiber, satellite, wireline, and/or wireless circuits. In an embodiment, the digital protocol transmission servers 319 may encapsulate content data into a form of the standard Internet Protocol (IP) for transmission through an IP gateway and associated Internet channels to the user terminals. The wide area distribution system 203 may comprise television and radio broadcast antennas 325, satellite uplink antennas 326, wireless distribution antennas 327, coaxial cable, optical fiber, and twisted pair transmission infrastructure 330, one or more digital protocol transmission gateways 332, and associated communications channels and circuits that connect the content transmission systems 283 to the user terminals 202. In FIG. 16, the content transmission router 281 is shown as existing both inside and outside the boundary of the content transmission system 281 to indicate that one or more hardware systems and/or software modules and the associated functions that comprise the content transmission router 281 may be of a distributed nature and therefore may reside partly or wholly within the communications system 280 and/or within one or more of the content transmission systems 283. As such, the functionality of the content transmission router 281 may extend into one or more content transmission systems 283 and may be capable of routing content data and transport streams between one or more of the components and/or subsystems of the content transmission systems 283.

Within the content transmission system 283 one or more content transmission encoders 310 may perform final encoding of content data as may be necessary for transmission by the content transmission system 283 through one or more of the communications channels and/or circuits 335. Encoding performed by the content transmission encoders 310 may include, but is not limited to, scrambling, interleaving, and forward error correction coding such as Reed-Solomon, concatenated, and spread-spectrum coding. Two or more content data signals may be combined by one or more content transmission multiplexers 311 so that multiple content channels and/or signals may be transmitted simultaneously on a single transmission carrier. Such multiplexed signals may allow the content transmission system to carry numerous programs and/or content downloads through one transmission path to one or more user terminals simultaneously. A multiplexed signal may contain user terminal 202 addressing and authorization data to allow specific user terminals 202 access to desired portions of, or channels within, the multiplexed signal while ignoring content intended for consumption by other user terminals 202. One or more content signals, whether encoded and/or multiplexed, may then be operated on by one or more content transmission modulators 312 that modulate the content data signals onto one or more carrier frequencies appropriate for transmission over one or more communications channels. One or more modulated content signals may then be routed through one or more content transmitters for appropriate frequency conversion and/or amplification for transmission using one or more components of the wide area distribution system 203 that will transmit the signal(s) to one or more user terminals 202. In an embodiment, two or more of the functions performed by components within the content transmission system 283 may be performed within a single piece of equipment or group of equipment so that a discrete component may not be necessary to perform each step or function of the transmission system process.

The wide area distribution system 203 may comprise numerous elements collocated with the communication system 280 of the aggregator 201 as well as distributed public and/or private infrastructure elements and elements that are collocated with one or more user terminals 202. As shown in FIG. 16, elements of the wide area distribution system 203 that are collocated with the content transmission systems 283 of the communications system 280 may include one or more television and radio broadcast antennas 325, satellite uplink antennas 326, wireless distribution antennas 327, coaxial cable and/or optical fiber transmission infrastructure 330, and one or more digital protocol transmission gateways 332. Elements of the wide area distribution system 203 that comprise distributed public and/or private infrastructure elements (not shown in FIG. 16) may comprise one or more of the physical space representing the public airwaves supporting broadcast, satellite, and wireless transmissions, one or more orbiting communications satellites, and one or one distributed portions of coaxial cable, fiber optic, telephone, and/or twisted-pair wire communications networks. Elements (not shown in FIG. 16) of the wide area distribution system 203 that may be collocated with one or more user terminals 202 may include reception elements to receive television and radio broadcast signals, satellite and other wireless transmissions, and various analog and/or digital signals transmitted over one or more distributed portions of coaxial cable, fiber optic, telephone, and/or twisted-pair wire communications networks.

The content transmission system 283, the wide area distribution system 203, and reception elements that may be collocated with user terminals may be scalable and interoperable with a large number of different types of communications systems in order to provide a high degree of flexibility for transmission of content to system users and may be able to accommodate integration with yet-to-be-developed broadcast and transmission systems compatible with distribution of content by the content search, packaging, and delivery system 200. The communications system 280 in conjunction with the wide area distribution system 203 may be capable of delivering content over two or more communications systems and/or paths simultaneously so that a user terminal 202 may be able to receive content over different communications channels at the same time. The determination as to what content may be transmitted over which communications system or path may be determined by the communications system 280 and may be based on factors including, but not limited to, bandwidth availability among various communications channels, format and required bandwidth of the content to be delivered, overall system loading, and source and target locations and/or identities.

The communications system 280 may include one or more user data transceivers 285 that comprise software and/or hardware modules that may transmit and receive data other than content data to and from the aggregator 201 and the user terminals 202. The user data transceivers 285 may connect the communications server 250 through the wide area distribution system 203 to one or more user terminals 202 for the transfer of data including but not limited to, user content search requests and content download requests, notification prompts regarding requested content availability, user profile data, user history and usage data, billing information, advertising, programming schedule data, service availability data, and other administrative information. In an embodiment, the user data transceivers 285 may comprise one or more computer server systems operably connected to one or more of the communications channels within the wide area distribution system 203. Transmission of user data by the user data transceivers 285 from the communications server 250 to one or more user terminals 202 may be through one or more separate, dedicated communications channels or may be through one or more control and data channels that may occupy the same transmission path as one or more of the content transmissions. In an embodiment, the transmission of user data may be multiplexed with content data. Depending on the type of communications channel used to connect a given user terminal 202 to the communications system 280, the user data transceivers 285 may transmit data directly through one or more components of the wide area distribution system 203, such as one of the digital protocol transmission gateways 332, and/or may transmit data through one of the content transmission systems 283, such as one or more of the satellite transmitters 316 and/or wireless system transmitters 317. In an embodiment, the forward transmission path from the communications system 283 to the user terminal 202 may be different than that of the return transmission path form the user terminal 202 to the communications system 283. For example, a user terminal 202 may receive user data, such as the results of a content search, multiplexed with another content download that is delivered using a satellite transmission path and the user terminal 202 may upload user data, such as user profile and history data, using an Internet connection through one of the digital protocol transmission gateways 332.

Delivery of content to system users may be done through the exchange of physical media such as videotape, digital video disk (DVD), and/or CD-ROM. To support physical media delivery of content, the communications system 280 may encompass a physical media production unit 287 (shown in FIG. 16), which may be connected to the communications server 250 to receive instructions and parameters for production of physical content media and which may be connected to the content transmission routers 281 to receive content data to be recorded onto physical media. The physical media production unit 287 may be fully or partially automated and may or may not require human interaction and/or supervision. The communications server 280 may transmit production parameters to the production unit 287 including, but not limited to, identification of the content to be recorded onto physical media, the type or physical media to be used, identification information of the system user or users to receive the content on physical media, routing information for the source content data, and packaging and physical delivery information. The content transmission routers 281 may then route the appropriate content data to one or more components of the physical media production unit 287 for recording onto physical media. Physical media for content delivery may include, but is not limited to, magnetic tape, optical disks, removable computer disks, and other yet-to-be-developed media for storage and consumption of programming content. An example might be a DVD that may contain one or more Tarzan films along with digital replications of Tarzan movie posters and electronic book versions of the corresponding novels by Edgar Rice Burroughs. Physical media may be delivered to system users through the physical media distribution channels 289 shown in FIG. 16. The physical media distribution channels 289 may include the U.S mail, private shipping organizations, one or more shipping organizations specific to the content search, packaging, and delivery system 200, and/or retail outlets operating under agreement with the operators of the system 200. In an embodiment, one or more physical media production units 287 may be located remotely from the aggregator 201 and the communications system 280, such as at a wholesale or retail location, and may receive production parameters and content data from the communications server 250 through channels within wide area distribution system 203.

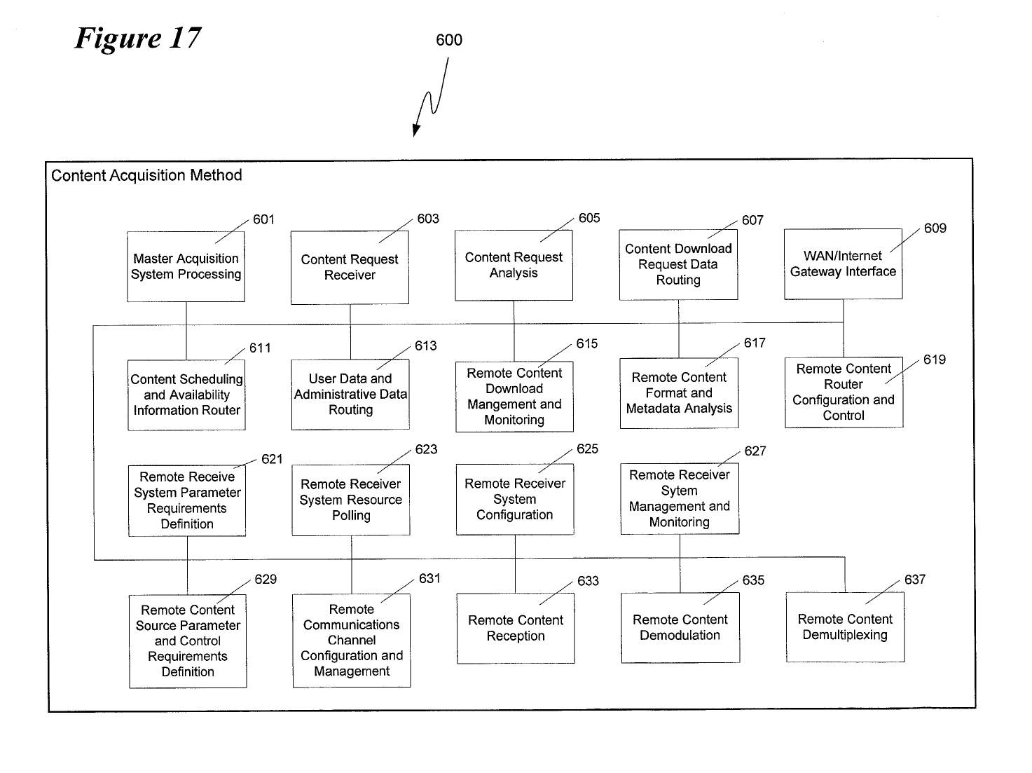

FIG. 17 is a diagram of processing modules comprising a content acquisition method 600 that may reside in one or more of the components of a content acquisition system 405 shown in FIG. 11, and may control operations of the content acquisition system 405. The content acquisition method 600 includes a master acquisition system processing module 601 that is coupled to one or more other processing modules within the content acquisition method 600 and that may manage the configuration and operation of one or more other processing modules within the content acquisition method 600. The acquisition system processing module 601 may also be operably connected to and may communicate and interact with other systems of the aggregator 201 including, but not limited to, a network gateway 251, a system administrator 500, a request and results processing server 300, a content delivery system 460, and one or more codec and content formatters 270. In an embodiment, the processing modules within the content acquisition method 600 may be interconnected using a bus topology that may allow dynamic interconnectivity between up to all of the processing modules and may support logical addressing of modules for communications routing. The master acquisition system processing module 601 may be coupled to a content request receiver 603 that may communicate with the request and results processing server 300 and to receive electronic requests for remote content download. The content request receiver 603 may be coupled to a content request analysis module 605 which may operate on the content request to identify information within the request that is necessary to acquire and deliver the requested content. This analysis may include logging of user information, verification of user authorization, identification of requested content and format requirements, and creation and distribution of a list of tasks required to fulfill the download request. The content request analysis module 605 may be coupled to a content download request data routing module 607 that may route and/or transmit appropriate content download request data to one or more remote content sources 410 (see FIG. 11) by means of a wide area network (WAN)/Internet gateway interface module 609. The WAN/Internet gateway interface module 609 may interact with a network gateway 251 and may facilitate communications between the content acquisition method 600 and one or more remote content sources 410 through the wide area network/Internet 205.

During the acquisition process, a content scheduling and availability information routing module 611 may submit scheduling and availability information about the selected content to the database administrator 502 within the system administrator 500, which in turn routes this scheduling and availability information to a scheduled program and content availability prompt and notification processor 306 within the request and results processing server 300 (see FIG. 5). Also during the acquisition process, a user data and administrative data routing module 613 may route data concerning system users and other administrative processes to one or more processors within the system administrator 500, the content acquisition system 405, and/or one or more user terminals 202. Such user and administrative data may include users search and download request history, billing information, content copyright data, and digital rights management data, and advertising data.

A remote content download management and monitoring module 615 may be coupled to the system processing module 601, the WAN/Internet gateway interface 609, and a remote communications channel configuration and management module 631 to communicate with one or more remote content sources 410 to manage the transfer and/or download of content from remote content sources 410 to the content acquisition system 405. A remote content format and metadata analysis module 617 may compare content format information and metadata associated with remote content against download and/or storage format requirements to determine if the remote content needs to be routed to one or more codec and content for matters 270 prior to delivery to one or more system users and/or storage within the aggregator local storage 254. The format and metadata analysis module 617 may then communicate coding and formatting requirements to the master acquisition system processing module 601 for use in content routing configuration. The system processing module 601 may be coupled to a remote content router configuration and control module 619 that may control one or more hardware and/or software components of one or more content acquisition routers 405 to establish and manage logical and/or physical circuit connections for transmission of content data between the various subsystems shown in FIG. 11.

A remote receive system parameter definition module 621 may be coupled to the system processing 601 and other modules within the content acquisition method 600 and may use download request data and data about available remote content to define remote receive system parameters required for the configuration and control of one or more of content acquisition receiver systems 408. The remote receive system parameters may then be used by the remote receiver system resource polling module 623 to identify required and available receiver system 408 resources to fulfill the content acquisition request. Once receiver system resources have been identified, the remote receiver system configuration module 625 uses resource identification data and receiver system parameters to configure one or more content acquisition receiver systems 408 to receive the requested remote content. After one or more receiver systems 408 have been configured, the remote receiver system management and monitoring module 627 may oversee the receiver systems 408 during the remote content transfer and may communicate with the master acquisition system processing module 601 and one or more remote content sources 410 to ensure proper delivery of remote content to the content acquisition system 405 and ultimately through the content acquisition routers 406 to the content delivery system 460 and the communications system 280 for transmission to one or more system users.

A remote content source parameter definition and transmission module 629 is coupled to the system processing 601 and other modules within the content acquisition method 600 and may use download request data and data about available remote content and/or remote content sources 410 to define configuration and/or operational parameters required by one or more remote content sources 410 to deliver remote content to one or one content acquisition receiver systems 408 and may then transmit these parameters to one or one remote content sources 410. A remote communications channel configuration and management module 631 may be coupled to the master acquisition system processing 601 and one or other modules and may use download request data and remote content source parameters and identification data to configure and manage one or more remote communications channels 409 for transmission of remote content to the content acquisition system 405. The remote communications channel configuration and management module 631 may also communicate with one or more remote content sources 410 to facilitate configuration of one or more remote communications channels 409 between one or more remote content sources 410 and one or more content acquisition receiver systems 408.

A remote content reception module 633 may be coupled to one or more modules within the content acquisition method 600 and may receive signals containing remote content from one or more remote communications channels 409 and may route these signals to a remote content demodulation module 635 that may act on the received electronic signals to filter analog and/or digital content data streams from one or more modulated carriers using one or more modulation schemes. The remote content demodulation module 635 may then route one or more demodulated signals to a remote content demultiplexing module 637 that may separate elementary streams or individual channels of content data from one or more multi-channel streams and may make this data available to the remote content router configuration and control module 619 for transmission to other appropriate subsystems.

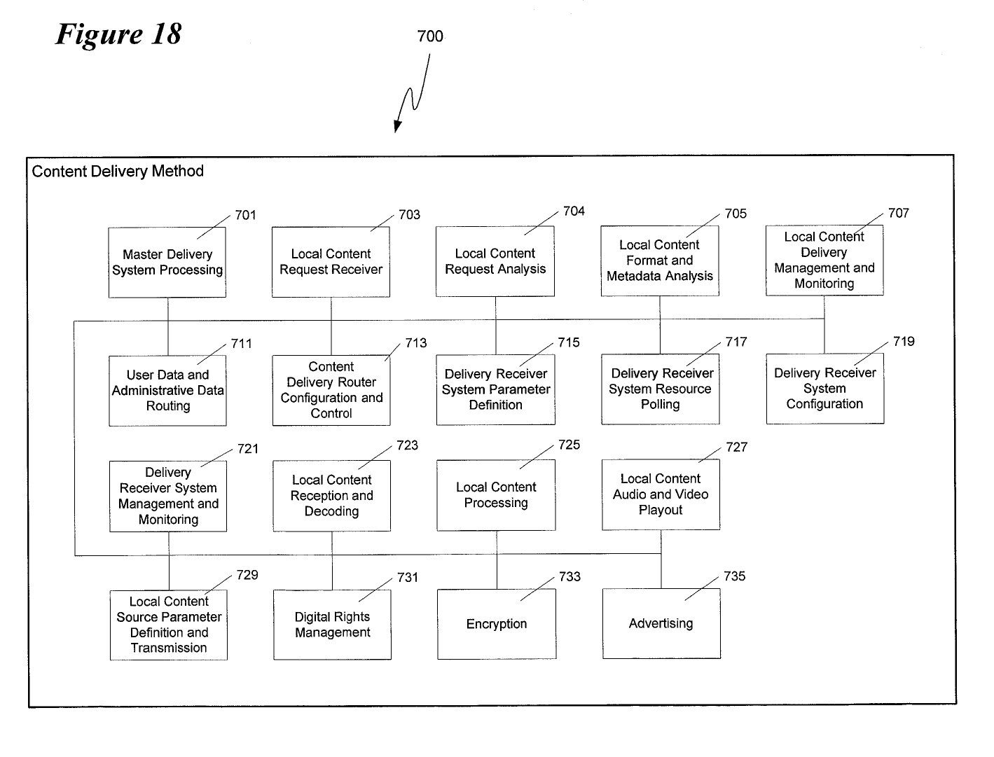

FIG. 18 is a diagram of processing modules comprising a content delivery method 700 that may reside in one or more of the components of a content delivery system 460 shown in FIG. 13, and may control operations of the content delivery system 460. The content delivery method 700 includes a master delivery system processing module 701 that is coupled to one or more other processing modules within the content delivery method 700 and that may manage the configuration and operation of one or more other processing modules within the content delivery method 700. The delivery system processing module 701 may also be operably connected to and may communicate and interact with other systems of the aggregator 201 including, but not limited to, a system administrator 500, a communications system 280, a content acquisition system 405, one or more codec and content formatters 270, and one or more local content sources 475. In an embodiment, the processing modules within the content delivery method 700 may be interconnected using a bus topology that may allow dynamic interconnectivity between up to all of the processing modules and may support logical addressing of modules for communications routing. The master delivery system processing module 701 may be coupled to a local content request receiver 703 that may receive electronic requests from the request and results processing server 300 (see FIG. 5) and/or the content request processor and router 401 (see FIG. 6) requesting delivery of locally available content to one or more aggregator 201 system users. The local content request receiver 703 may be coupled to a local content request analysis module 704 which may operate on the local content delivery request to identify information within the request that is necessary to identify one or more local content sources 475 able to provide the requested content and deliver the requested content to one or more system users. The analysis of the local content request may include logging of user information, verification of user authorization, identification of requested content and format requirements, and creation and distribution of a list of tasks required to fulfill the delivery request.

A local content delivery management and monitoring module 707 may be coupled to the system processing module 601 and one or more local content sources 475 to manage the transfer and/or delivery of content from local content sources 475 to the content delivery system 460. A local content format and metadata analysis module 705 may compare format information and metadata associated with the local content against delivery format requirements to determine if the local content needs to be routed to one or more codec and content for matters 270 prior to delivery to one or more system users. The format and metadata analysis module 705 may then communicate coding and formatting requirements to the master delivery system processing module 701 for use in content routing configuration. During the local content delivery process, a user data and administrative data routing module 711 may route data concerning system users and other administrative processes to one or more processors within the system administrator 500, the content delivery system 460, and/or one or more user terminals 202. Such user and administrative data may include user search and download request history, billing information, content copyright data, and digital rights management and advertising data. The system processing module 701 may be coupled to a content delivery router configuration and control module 713 that may control one or more hardware and/or software components of one or more content delivery routers 461 to establish and manage logical and/or physical circuit connections for transmission of content data between the various subsystems shown in FIG. 13.

A delivery receiver system parameter definition module 705 may be coupled to the system processing 601 and other modules within the content delivery method 700 and may use download request data and data about available local content to define delivery receiver system parameters required for the configuration and control of one or more of content delivery receiver systems 463. The delivery receiver system parameters may then be used by the delivery receiver system resource polling module 717 to identify required and available delivery receiver system 463 resources to fulfill the content delivery request. Once delivery receiver system resources have been identified, the delivery receiver system configuration module 719 uses resource identification data and delivery receiver systems parameters to configure one or more content delivery receiver systems 463 to receive the requested local content. After one or more delivery receiver systems 463 have been configured, the delivery receiver system management and monitoring module 721 may oversee the receiver systems 463 during the local content transfer and may communicate with the master delivery system processing module 601 and one or more local content sources 475 to ensure proper delivery of content through the content delivery routers 461 to the communications system 280 for transmission to one or more system users.

A local content source parameter definition and transmission module 729 may be coupled to the system processing module 701 and other modules within the content delivery method 700 and may use download request data and data about available local content and/or local content sources 475 to define configuration and/or operational parameters required for one or more local content sources 475 to deliver local content to one or one content delivery receiver systems 463 and may then transmit these parameters to one or one local content sources 475. A local content reception and decoding module 723 may be coupled to one or more modules within the content delivery method 700 and may receive files and/or data transport streams containing local content from one or more local content sources and may perform any necessary decoding of content and may route these signals to a local content processing module 725. The local content processing module 725 may perform processing functions on the content data that may include adjusting audio levels, combining and/or splitting audio and/or video signals, and adjusting video luminance and chrominance as required for delivery. A local content audio and video playout module 727 may be coupled to one or more other modules of the content delivery method 700 and may serve the function of accessing audio and video content that is stored in aggregator local storage 254 and making this content available as one or more audio and/or video streams for routing to the communications system 280 for delivery to one or more system users.

As a result of processing performed by content delivery modules such as the request analysis module 704 and the local content format and metadata analysis module 705, the system processing module 701 may determine that the one or more content files and/or data transport streams may require application of digital rights management schemes, encryption schemes, and/or advertising. Application of these attributes to the content to be delivered may be performed by a digital rights management module 731, an encryption module 733, and an advertising module 735 respectively. The digital rights management module 731 may incorporate mechanisms within the content delivery that may serve to protect the copyrights reserved by the content providers by assigning one or more system users specific and/or limited rights defining how the content may be used. As an example, a user may be allowed to playback a particular program an unlimited number of times, but may be prevented from copying the program onto removable media. The encryption module 733 may apply one or more encryption schemes to content for delivery that may serve to prevent reception of content by parties other than the intended system user recipients. When encryption is used, system users that are authorized to receive encrypted content may possess particular digital information, such as an encryption key, that may be necessary to decrypt content by a user terminal 202. The advertising module 735 may incorporate various types of advertising with content data for delivery to system users and/or may incorporate advertising placeholders that may be used by a user terminal 202 to insert or overlay advertising with delivered content where the advertising may have been downloaded at an earlier time and may be resident on the user terminal 202.

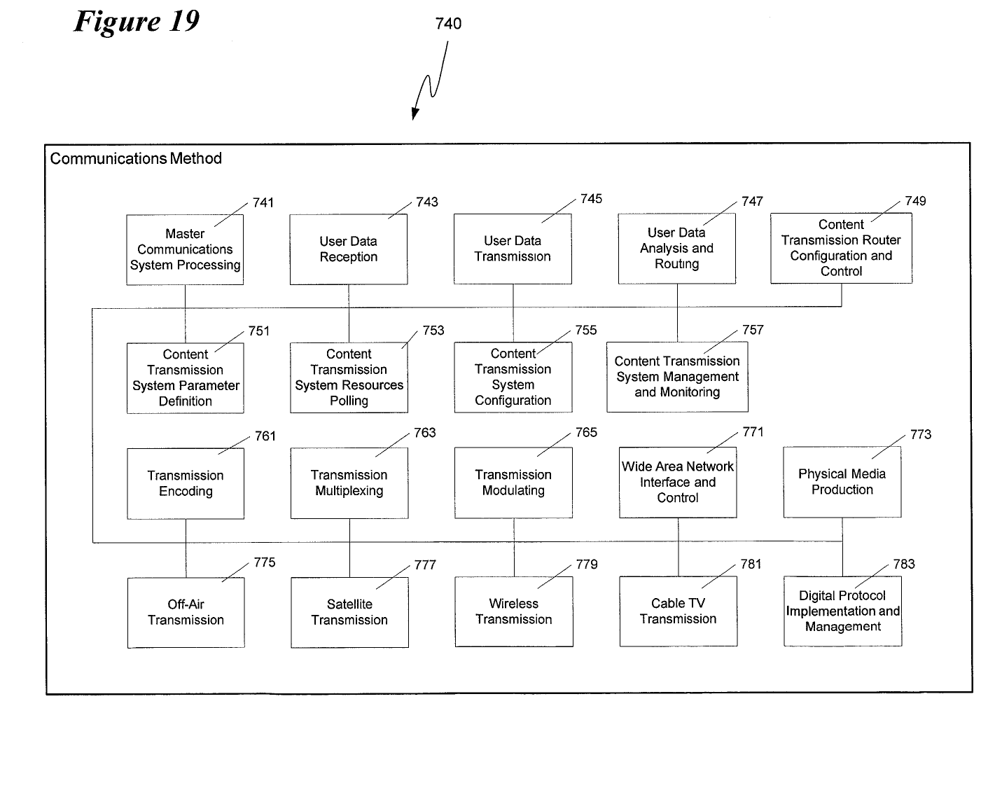

FIG. 19 is a diagram of processing modules comprising a communications method 740 that may reside in one or more of the components of a communications system 280 shown in FIG. 15, and may control operations of the communications system 280. The communications method 740 includes a master communications system processing module 741 that is coupled to one or more other processing modules within the communications method 740 and that may manage the configuration and operation of one or more other processing modules within the communications method 600 to transmit content, user, and administrative data from the aggregator system 201 to one or more user terminals 202 and to transmit user and administrative data from one or more user terminals 202 to the aggregator 201. The communications system processing module 741 may also be operably connected to and may communicate and interact with other systems of the aggregator 201 including, but not limited to a system administrator 500, a request and results processing server 300, a content delivery system 460, and one or more components of a wide area distribution system 203. In an embodiment, the processing modules within the communications method 740 may be interconnected using a bus topology that may allow dynamic interconnectivity between up to all of the processing modules and may support logical addressing of modules for communications routing.

The system processing module 741 may be coupled to a user data reception module 743 and a user data transmission module 745 that may be parts of the user data transceivers 285 shown in FIG. 15. The user data reception module 743 interfaces with the wide area distribution system 203 to receive incoming user data transmitted by one or more user terminals 202. The user data reception module 743 may be coupled to a user data analysis and routing module 747 that examines the incoming user data to determine the type of message that is received and to route it accordingly. For example, information updating a system user's profile may be routed to the system administrator 500 and program search and download requests may be routed to the request and results processing server 300. A user data transmission module 745 may be coupled to the system processing module 741 and other modules of the communications method 740 in order to transmit user and administrative data from the aggregator system 201 to one or more user terminals 202. User data to be transmitted may include program availability notification, program search results, advertising, program schedules, billing information, and other administrative data.

The system processing module 741 may be coupled to a content transmission router configuration and control module 749 that may control one or more hardware and/or software components of one or more content transmission routers 281 to establish and manage logical and/or physical circuit connections for transmission of content data between the various subsystems shown in FIG. 15. The system processing module 741 may also be coupled to a content transmission system parameter definition module 751 that analyzes content delivery requirements and determines system parameters required to configure one or more content transmission systems 283 to fulfill content delivery. The transmission system parameters may then be used by a content transmission system resource polling module 753 to identify required and available content transmission system 283 resources to fulfill the content delivery. Once transmission system resources have been identified, a content transmission system configuration module 755 uses resource identification data and transmission parameters to configure one or more content transmission systems 283 to deliver content to one or more user terminals 202. After one or more content transmission systems 283 have been configured, the content transmission system management and monitoring module 757 may oversee the transmission systems 283 during the content transfer and may communicate with the master communications system processing module 741 and one or more other modules within the communications method 740 to ensure proper delivery of content through the wide area distribution system 203 to one or more system users.

A transmission encoding module 761 may reside in one or more content transmission systems 283 and may be coupled to the system processing module 741 and other modules within the communications method 740 and may apply one or more encoding schemes to one or more content files, content data streams, and/or user and administrative data files for transmission through one or more components of a wide area distribution system 203. The transmission encoding module 761 may be coupled to a transmission multiplexing module 763 that may operate on two or more content signals to combine the signals into a single composite signal to be transmitted over a single channel carrier. One or more content signals, whether encoded and/or multiplexed, may then be operated on by a transmission modulating module 765 that may modulate one or more content data signals onto one or more intermediate and/or carrier frequencies appropriate for transmission through one or more components of a wide area distribution system 203.

Once one or more content transmission signals have been encoded, multiplexing, and/or modulated, the signals are forwarded to one or more a of the following modules coupled within the communications method for transmission of content to one or more user terminals 202 through a wide area distribution system 203: an off-air transmission module 775, a satellite transmission module 777, a wireless transmission module 779, a cable television transmission module 781, and a digital protocol implementation and management module 783. The off-air transmission module 775 may control components that may transmit content data over one or more television and radio broadcast channels using one or more broadcast antennas 325 as shown in FIG. 16. The satellite transmission module 777 may control components that may transmit content data through one or more communications satellites using one or more satellite uplink antennas 326. The wireless transmission module 779 may control components that may transmit content data through one or more wireless distribution channels using one or more wireless distribution antennas 327. The cable television transmission module 781 may control components that may transmit content data through one or more cable headend systems using one more coaxial cable and/or fiber transmission infrastructure 330 components. The digital protocol implementation and management module 783 may reside on one or more digital protocol transmission servers 319 and may encapsulate content for transmission using one or more industry standard and/or proprietary digital protocols through one or more digital protocol transmission gateways 332. The wide area network interface and control module 771 may be coupled to various modules within the communications method 740 and may identify, configure, and/or control components and/or modules providing the interfaces between the content transmission systems 283 and the wide area distribution system 203.

A physical media production module 773 may be coupled to the system processing module 741 and other modules within the communications method 740 and may oversee the automated portion of production of content onto physical media such as DVD, CD-ROM, magnetic tape, and other media suitable for distribution of content by the aggregator system 201. The physical media production module 773 may receive instructions and parameters for production and distribution of physical content media from the system processing module 741 and may be coupled to the content transmission routers 281 to receive content data to be recorded onto physical media.

In the claims:

1. A video and multimedia acquisition and delivery system, comprising:
a content acquisition system, comprising:
a content acquisition server that receives video and multimedia content requests and controls acquisition of the requested video and multimedia content,
one or more content acquisition routers coupled to the content acquisition server that route the video and multimedia content requests and acquired video and multimedia content, and
a content acquisition receiver system coupled to the one or more content acquisition routers, wherein the content acquisition receiver system receives video and multimedia content from remote sources and provides the received video and multimedia content to the one or more content acquisition routers; and
a content delivery system coupled to the content acquisition system, comprising:
a content delivery server, and
one or more content delivery routers coupled to the content delivery server.

2. The system of claim 1, wherein the content acquisition server, comprises:
a content request processor and router that receives the video and multimedia requests from a user terminal;
a buffer coupled to the content request processor and router; and
a remote content download processor coupled to the content request processor and router, wherein the remote content download processor manages a connection from remote content sources.

3. The system of claim 2, wherein the content delivery server maintains a connection to the user terminal for delivery of video and multimedia content.

4. The system of claim 2, wherein the video and multimedia content includes the video and multimedia content and metadata related to the video and multimedia content, and wherein the video and multimedia content is routed through the video and multimedia content acquisition system.

5. The system of claim 2, wherein the video and multimedia content includes metadata related to the video and multimedia content, and wherein the video and multimedia content is routed to the user terminal through a remote network gateway to the content delivery server coupled to the network gateway.

6. The system of claim 1, wherein the content acquisition receiver system comprises:
one or more acquisition receivers;
one or more acquisition demodulators coupled to the one or more acquisition receivers, and
one or more acquisition demultiplexers coupled to the one or more acquisition demodulators, wherein the one or more acquisition demultiplexers demultiplex receive content to provide requested video and multimedia content to the content delivery system for delivery to a user terminal.

7. The system of claim 1, wherein the content delivery server, comprises:
a local request processor; and
a content delivery processor coupled to the local request processor and wherein the content delivery system stores video and multimedia content in a local content source buffer until a connection to a user terminal is made.

8. The system of claim 1, wherein the content delivery server comprises an advertisement processor that receives commands to insert specific advertisements into video and multimedia content, wherein the specific advertisements are stored at one of a remote location and a user terminal.

9. The system of claim 1, wherein the content delivery server comprises a digital rights management (DRM) processor and an encryption processor, wherein the DRM processor comprises:
a storage module that determines if video and multimedia content may be stored at a user terminal, copied, forwarded to another user terminal, transferred to a computer-readable medium, and translated into an alternate file format and coding scheme; and
an encryption module that determines if the video and multimedia content may be encrypted, and wherein the encryption processor encrypts the video and multimedia content.

10. The system of claim 1, further comprising a system administrator that receives a notification of receipt of the requested video and multimedia content by a user terminal, and processes billing information based on receipt of the content.

11. A method for acquiring and delivering video and multimedia content, comprising:
receiving a content download request from a user terminal;
determining if the request is a local download or a remote download;
if the request is a remote download request, determining if the content is to be delivered directly or indirectly; and
if the delivery is to be delivered directly:
establishing a communications link from a remote content server to the user terminal,
delivering the requested content to the user terminal,
validating the delivery to the user terminal, and
logging the validated delivery in one of a local and a remote server database.

12. The method of claim 11, wherein the request is a local download request, comprising:
analyzing metadata related to the requested content;
determining, based on the analyzed metadata, if the requested content is in a correct format for delivery to the user terminal;
if the requested content format is not correct:
retrieving the requested content,
decoding the requested content, and
reformatting the requested content into a required format for delivery to the user terminal;
if the requested format is correct, routing the requested content to a content delivery server;
analyzing a user profile associated with a user of the user terminal and the content metadata; and
based on the analyzed user profile and the content metadata:
applying a digital rights management scheme to the content delivery, and
incorporating one or more advertisements into the requested content,
wherein one or more of the one or more advertisements are targeted to a user of the user terminal.

13. The method of claim 11, wherein the requested content is to be delivered indirectly, comprising:
acquiring the requested content at a remote acquisition server;
determining if the requested content should be stored at an aggregator local storage;
if stored at the aggregator local storage:
determining a format of the requested content,
if the format if the requested content is not correct for storage, reformatting the request content, and
if the format of the requested content is correct for storage, storing the requested content;
analyzing metadata related to the requested content;
determining, based on the analyzed metadata, if the requested content is in a correct format for delivery to the user terminal;
if the requested content format is not correct:
retrieving the requested content,
decoding the requested content, and
reformatting the requested content into a required format for delivery to the user terminal;
if the requested format is correct, routing the requested content to a content delivery server;
analyzing a user profile associated with a user of the user terminal and the content metadata; and
based on the analyzed user profile and the content metadata:
applying a digital rights management scheme to the content delivery, and
incorporating one or more advertisements into the requested content, wherein one or more of the one or more advertisements are targeted to a user of the user terminal.
